(19) United States
(12) Patent Application Publication
(10) Pub. No.: US 2025/0206077 A1
(43) Pub. Date: Jun. 26, 2025

(54) TIRE PRESSURE EQUALIZATION SYSTEMS AND VALVES

(71) Applicant: Pressure Systems International, LLC, San Antonio, TX (US)

(72) Inventor: Connor James, Schertz, TX (US)

(21) Appl. No.: 18/844,725

(22) PCT Filed: Mar. 7, 2023
(86) PCT No.: PCT/US2023/014757

§ 371 Date: Sep. 6, 2024

Related U.S. Application Data
(60) Provisional application No. 63/317,442, filed on Mar. 7, 2022.

(51) Int. Cl. B60C 23/00; B60C 29/06

(52) U.S. Cl. CPC B60C 23/00354; B60C 23/00318; B60C 23/00336; B60C 23/00345; B60C 23/00363; B60C 29/064; B60C 29/068; B60C 23/00381; B60C 23/0039; B60C 23/007; B60C 23/008; B60C 23/009

(57) ABSTRACT

Valves and related systems are described for equalization of pressure between vehicle tires. Valves may, for example, comprise a valve body which selectively opens when a vehicle is in motion so as to selectively allow two-way communication between vehicle tires.

### CROSS-REFERENCE TO RELATED APPLICATION

[none].

### FIELD

This application relates generally to vehicle tire pressure balancing and valves for equalizing pressure between vehicle tires, and further relates generally to inflation and deflation of vehicle tires.

### BACKGROUND

The pressure in the various tires of a vehicle may sometimes become unbalanced in relation to one another. For example, in a set of dual tires mounted to the end of a vehicle axle, the pressure of one tire may be different from the pressure in the adjacent tire. Such an imbalance may lead to the development of serious safety and performance issues for the vehicle. Such issues may include but not be limited to uneven traction, increased tire wear, vehicle instability, interference in the operation of onboard systems (i.e., brakes, collision mitigation systems, and other tire pressure reliant systems), and increased risk of blow-out on a tire. Existing systems for correcting imbalances in tire pressure may suffer from various deficiencies including, but not limited to, complexity and limited flow capacity. For example, some prior art systems may rely on a plurality of independently operating valves (e.g., diaphragm valves or other relief valves positioned at each wheel end of a vehicle) configured to equalize pressure between vehicle tires or relieve excess pressure to atmosphere. However, those systems may be difficult to maintain and may not always perfectly balance tires, particularly in situations wherein a tire becomes overinflated as may sometime occur due to variation in temperature or other factors.

There exists a need for systems and methods that are better equipped to handle overinflation of vehicle tires and that maintains an equal pressure in the appropriate sets of tires of a vehicle or trailer. There is a particular need for systems and methods that maintain an equal pressure in appropriate sets of tires without limiting flow capacity for vehicle tire inflation. Embodiments of system and methods described herein address the aforementioned needs and other needs as described herein.

### BRIEF DESCRIPTION OF THE DRAWINGS

FIG. 1 is a side elevation view of one embodiment of a tire pressure regulation system including a pair of tire pressure equalization valves mounted to a hubcap.

FIG. 2 is a cross-sectional view of a first embodiment of a tire pressure equalization valve.

FIG. 3 is a side elevation view of an exemplary embodiment of a valve body.

FIG. 4 is a view of the proximal end of the valve body shown in FIG. 3.

FIG. 5 is a cross-sectional side view of the valve body shown in FIG. 3 taken at section B1-B2 shown in FIG. 3.

FIG. 6 is a perspective view of the valve body shown in FIG. 3.

FIG. 7 is a cross-sectional side view of an exemplary embodiment of a valve housing.

FIG. 8 is a detailed cross-section of Detail A of FIG. 7.

FIG. 9 is a side elevation view of an exemplary embodiment of a connector.

FIG. 10 is a cross-sectional side view of the connector shown in FIG. 9 taken at section C1-C2 shown in FIG. 9.

FIG. 11 is a side view of another embodiment of a tire pressure regulation system including a pair of tire pressure equalization valves mounted to a hubcap.

FIG. 12 is a perspective view of the tire pressure regulation system shown in FIG. 11.

FIG. 13 is a cross-sectional view an exemplary embodiment of a valve.

FIG. 14 is a cross-sectional view of another embodiment of a tire pressure regulation system including a valve assembly.

FIG. 15 is a cross-sectional view another exemplary embodiment of a valve.

FIG. 16 is a cross-sectional view of an embodiment of a tire pressure regulation system for equalization of pressure between a pair of vehicle tires.

FIG. 17 is a perspective view of the tire pressure regulation system shown in FIG. 16.

FIG. 18 is a cross-sectional view of an exemplary embodiment of a flow control assembly.

FIG. 19 is a cross-sectional view of yet another embodiment of a tire pressure regulation system.

FIG. 20 is a side elevation view of a fluid conduit or air hose including a tire pressure equalization valve integrated therewith.

FIG. 21 is a schematic view of a metering device.

FIG. 22 is a schematic diagram of a pressure regulation system.

FIG. 23 is a schematic diagram of another embodiment of a pressure regulation system.

FIG. 24 shows an exemplary embodiment of a vehicle including a truck and a trailer.

FIG. 25 shows an exemplary embodiment of an automatic tire inflation system that may be used with a tire pressure equalization system.

### SUMMARY

In some embodiments, systems and methods are provided herein for regulating tire pressure. Systems may, for example, include one or more valves configured to open when a vehicle is in motion. For example, a valve may open in response to centrifugal forces induced by rotation of a wheel upon which the valve is mounted. When open, the valve may allow for pressure equalization between two or more tires. The valve may further allow for automatic inflation and/or deflation of one or more vehicle tires.

It is an objective of some embodiments of tire pressure regulation systems described herein to allow two-way fluid flow between two or more tires when a vehicle is travelling at or above a threshold speed. It is a further objective of some embodiments of tire pressure regulation systems to allow inflation of vehicle tires when the vehicle is stopped or moving below the threshold speed. For example, a pressure equalization valve may include a valve body comprising an inertial mass subject to centrifugal forces induced by rotation of a vehicle wheel, the valve body being contained in a housing allowing the valve body to translate therein so as to break a sealing contact made between the valve body and the valve housing when the vehicle reaches a threshold vehicle speed. The valve may further include an internal check valve integrated therein that allows for the inflation of vehicle tires when a pressure difference exists across the valve and the vehicle is stopped or moving below the threshold vehicle speed. For example, the check valve may be integrated within the valve housing or valve body in a way so that opening of the check valve does not depend on translation of the valve body. Accordingly, the check valve may be positioned within the valve body so that opening of the check valve is substantially independent of other forces related to vehicle motion. Advantageously, these embodiments enable automatic equalization between tires when a vehicle is traveling at highway speeds yet still helps to maintain proper tire pressure when the vehicle is stopped or traveling below highway speeds. Moreover, some of those embodiments meet the important objective of providing a system that selectively allows for two-way fluid flow when a vehicle is moving without sacrificing flow capacity of the inflation system.

In some embodiments of tire pressure regulation systems, a valve may comprise a valve body configured to translate within a valve housing so as to open the valve based on centrifugal forces when a wheel upon which the valve is mounted rotates. The valve body may further be subject to fluid pressure from fluid pressure sources on both the tire side and inflation side of the valve. In some embodiments, valves may be configured so that both centrifugal and pressure derived forces are substantial so that either of both group of forces may affect operation of the valve. This may be contrasted with other valves configured so that their operation is substantially independent of forces derived from fluid pressure.

It is an objective of some embodiments of tire pressure regulation systems described herein to provide a valve comprising a valve body subject to centrifugal forces when a wheel upon which the valve is mounted rotates. In some embodiments, the valve body may be subject to fluid pressure from fluid pressure sources on both the tire side and inflation side of the valve. It is an objective of some embodiments to provide a valve that seals, even at highway speeds, under certain circumstances. For example, it may be desirable to close a valve when pressure from an internal fluid pressure source is not providing a significant force upon the valve body. In those cases, fluid pressure from the tire side of the valve may work together with one or more biasing spring to help keep the valve closed.

It is an objective of some embodiments to provide a valve that seals, even at highway speeds, under certain circumstances. For example, it may be desirable to close a valve when pressure from an internal fluid pressure source is not providing a significant force upon the valve body. In some embodiments, fluid pressure originating from the tire side of the valve may, for example, work together with one or more biasing springs to help keep the valve closed even at highway speeds.

In some embodiments, a tire pressure regulation system may include a valve comprising a valve body which is moveable when subjected to centrifugal forces when a wheel upon which the valve is mounted rotates. The valve body may be contained within a housing comprising an auxiliary port. The auxiliary port may, for example, include a pressure relief valve configured to relieve excess pressure from the tire side of the valve.

It is an objective of some embodiments herein to provide a system for tire pressure regulation including a valve that is integrated together with a rotary union or otherwise configured for operation when positioned nearby or adjacent to the axis of rotation of a vehicle wheel end.

### DETAILED DESCRIPTION

This disclosure is generally directed to systems and methods for automatic regulation of vehicle tire pressure including, for example, equalization of air pressure between vehicle tires, such as a set of dual tires mounted to the ends of a vehicle axle. In some embodiments, valves and related components are described herein for automatically controlling both vehicle tire inflation and deflation. In some embodiments, valve or valve systems are described for equalization of pressure between two or more tires, such as dual tires mounted at an end of a vehicle axle.

An ATIS may generally include a fluid pressure source coupled to vehicle tires for providing fluid pressure to automatically inflate the vehicle tires in the event that a tire becomes under inflated. One or more valves may be used to control the flow of fluid to and/or from the vehicle tires.

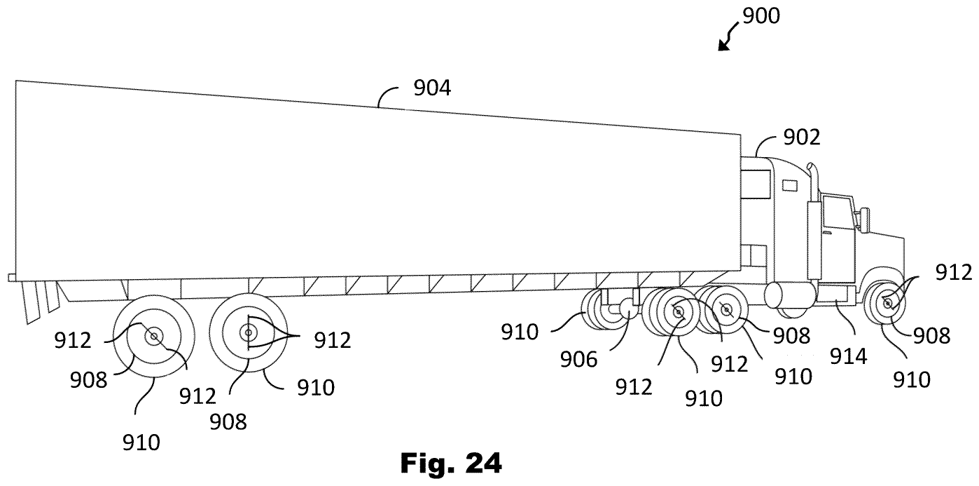

As may be seen in FIG. 24, a vehicle 900 may comprise a truck 902 and a trailer 904. The truck 902 may include one or more drive axles 106 as part of the vehicle's powertrain. The truck 902 may further include a steer axle (not shown in detail) having pivotable spindles that may provide steering capability for the vehicle 900. The trailer 904 may include one or more fixed axles (not shown). Each axle may have one or more wheels 908 mounted thereto. A pneumatic tire 910 may be mounted to each wheel 908. Each axle may have two or more tires attached at each end of the axle, such as the set of two tires 910 (dual tires) on each end of the trailer axle and drive axle 906 shown in FIG. 24.

In some embodiments, the vehicle 900 may be provided with tire pressure equalization system that maintains each set of dual tires 910 at a substantially equal air pressure. The tire pressure equalization system may be used to equalize air pressure between each tire of the dual tire set 910. As shown in FIG. 24, the tire pressure equalization system may include air hoses 912 in fluid communication with each tire of the set 910 for communicating air between the tires of the dual tire set 910. Such systems may equalize tire pressure, via a set of tire pressure equalization valves mounted at the wheel end.

In some embodiments, the vehicle 900 may be further provided with an automatic tire inflation system (ATIS) that uses pressurized air from the vehicle's air brake system or some other source of pressurized air to maintain the tires 910 at a desired air pressure. The automatic tire inflation system may be used to control air pressure in one or more of the tires 910 mounted to the steer axle (not shown), drive axle 906 or trailer axles (not shown). As shown in FIG. 24, the automatic tire inflation system may include one or more air hoses 912 in fluid communication with each tire 910 for communicating air from an air pressure source 914 to and from one or more of the tires 910. Such systems may supply pressurized air, via a rotary union mounted on or in the wheel-end assembly, to the tires 910 so as to pressurize the tires 910. Such systems may route air through hoses positioned external to the vehicle, or route air through a sealed or unsealed axle. Such systems may be used to inflate trailer tires 910, and/or tires 910 mounted to the steer axles or drive axles 906 of a heavy truck. As described in more detail below, a tire pressure equalization system may be used with or without an automatic tire inflation system.

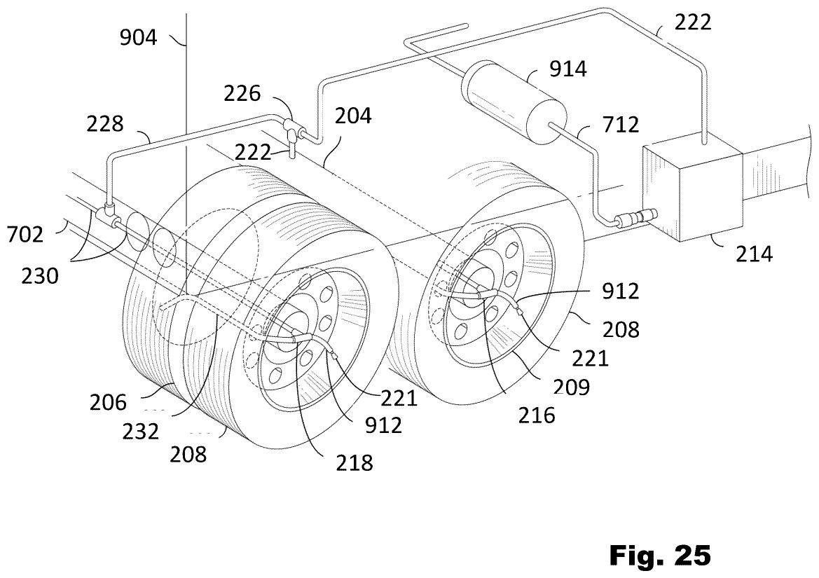

FIG. 25 illustrates an embodiment of an automatic tire inflation system that may be used with a tire pressure equalization system. A trailer 904 may include two axles 702 and 204. Dual tires 206 and 208 are mounted at each end of the axles 702 and 204. The automatic tire inflation system may generally include a pressure regulator 214 and one or more rotary air connections or rotary unions 216 and 218 mounted in or near the axle ends. The pressure regulator 214 may receive pressurized air from an air pressure source 914 through a conduit 712. The air pressure source 914 may comprise, for example, a vehicle air brake system air supply, or a step-up or booster pump. The pressure regulator 214 may control or reduce the air pressure from the air pressure source 914 to an air pressure level suitable for inflating the tires 206, 208, 910, such as, for example, at 110 psi. Pressurized air may flow from the pressure regulator 214 through conduits 222 and 228 to the axles 702 and 204.

The axles 702 and 204 may be wholly or partially solid or hollow, and may be configured in a variety of ways. For illustration purposes only, axles 702 and 204 are shown as hollow. For example, in some embodiments, an axle may comprise a solid beam having a spindle attached to each end (not shown). The axle spindles may be configured to allow mounting of wheel bearings upon which a hub may be rotatably mounted (not shown). In other embodiments, an axle may comprise a hollow tube having a spindle attached to each end. The spindles may be hollow, resulting in a hollow axle that is open at each end. Alternatively, the spindles may be wholly or partially solid, resulting in a hollow axle that is closed at each end.

If the axle is open at the end, the axle may be sealed so as to allow the hollow axle to hold pressurized air and to support air conduits or rotary air connections (or components thereof). The open end may also be provided with a plug or cap that may serve more to support air conduits or rotary air connections (or components thereof) than to seal the hollow axle to hold pressurized air.

In the embodiment of FIG. 25, axles 702 and 204 may be hollow sealed axles. In one embodiment, axle 204 may be hollow and may be sealed to serve as part of the conduit 222 for pressurized air. The air conduit 222 may be sealingly connected to the axle 204 to allow pressurized air to flow from the pressure regulator 214 to the axle 204. The pressurized air may flow through the axle 204 to a rotary air connection 216 mounted in or near the spindle end as described in more detail below. An air hose 912 may connect to the rotary air connection 216 to a valve stem 221 of the wheel 209 to which the first tire 208 is mounted, thus allowing pressurized air to flow to and/or from the tire 208. Another air hose may connect to the rotary air connection 216 to a valve stem of an adjacent wheel (not shown) to which a second tire is mounted, thus allowing pressurized air to flow to and/or from the tire 208.

In some embodiments, the air conduit 222 may be sealingly connected to a tee 226 to allow pressurized air to flow both to axle 702 and to axle 204. An air conduit 228 may, for example, allow pressurized air to flow from the tee 226 to a conduit 230 disposed in axle 702. Axle 702 may carry an air conduit 230 to communicate pressurized air to rotary air connection 218. Air hoses 912, 232 may connect the rotary air connection 218 to the valve stems 219 of the wheels to which tires 206 and 208 are mounted, thus allowing pressurized air to flow to and/or from the tires 206 and 208. In other embodiments, if the axle 702 is solid, then a channel may be bored in axle 702 to permit positioning of all or part of conduit 230 inside the axle 702.

In some embodiments described herein, valves used in a tire pressure equalization system may be radially mounted to a wheel end and configured to selectively open when a vehicle is in motion. For example, some valves described herein may comprise an inertial mass that is configured to slide within a valve housing away from the rotational axis of a vehicle wheel to which the valve is mounted due to centrifugal forces when the vehicle is in motion. This mass provides a force that is dependent upon the rotational speed of the wheel upon which a valve is mounted, and which may be sized to overcome a countering force to open at a selected or threshold vehicle speed. For example, in some embodiments, a valve may be configured to translate from a closed state to an open state when the vehicle is travelling at speeds of at least about 40 miles per hour to at least about 60 miles per hour. Because the valves permit two-way flow only during vehicle operation at a threshold speed, they may sometimes be used without separate check valves. In other embodiments, check valves may be integrated directly within the valve itself. This allows pressure equalization to be achieved using an automatic tire inflation system. Depending on the configuration of the ATIS, some embodiments herein may facilitate automatic pressure equalization between any given subset of tires not only those at a single wheel end, for example, between a first dual set of tires on one end of an axle and a second dual set of tires on the other end of the axle, or between all ties on a trailer.

In some embodiments, a pressure regulation system may include a valve including an inertial mass and an auxiliary port. The auxiliary port may, for example, be positioned downstream from a valve body seal so that the auxiliary port may be placed in fluid communication with a vehicle tire when the valve is closed. The auxiliary port may include a pressure relief valve configured to relieve excess pressure from the vehicle tire. This may, for example, be important in some valve systems involving an inertial mass wherein back pressure from the vehicle tire counterbalances centrifugal forces used to open the valve. For example, in such embodiments, the auxiliary port and pressure relief valve may be used to minimize variation in the vehicle speed at which the valve opens so as to allow two-way fluid flow to vehicle tires at about a desired vehicle speed.

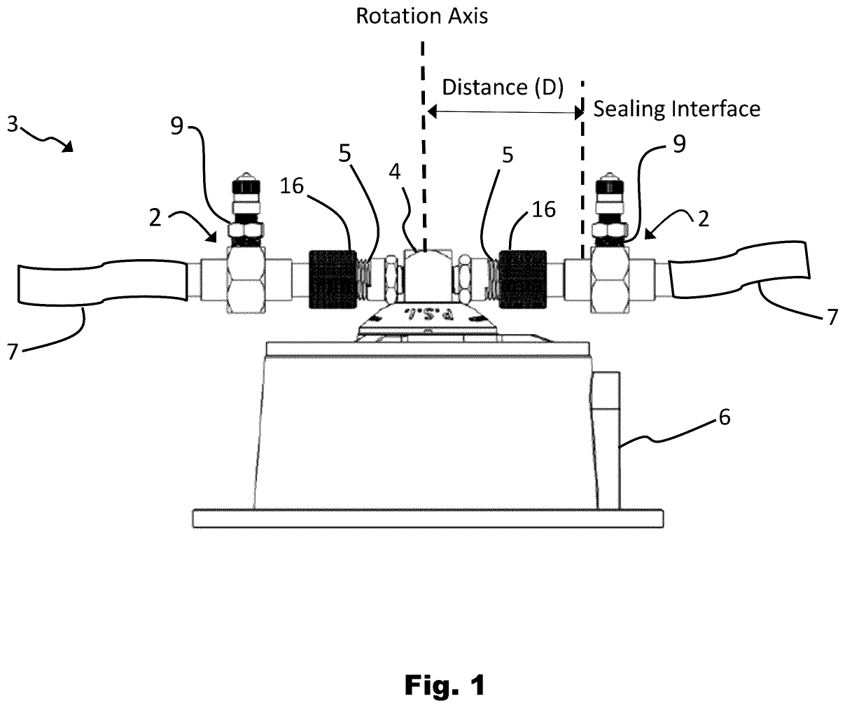

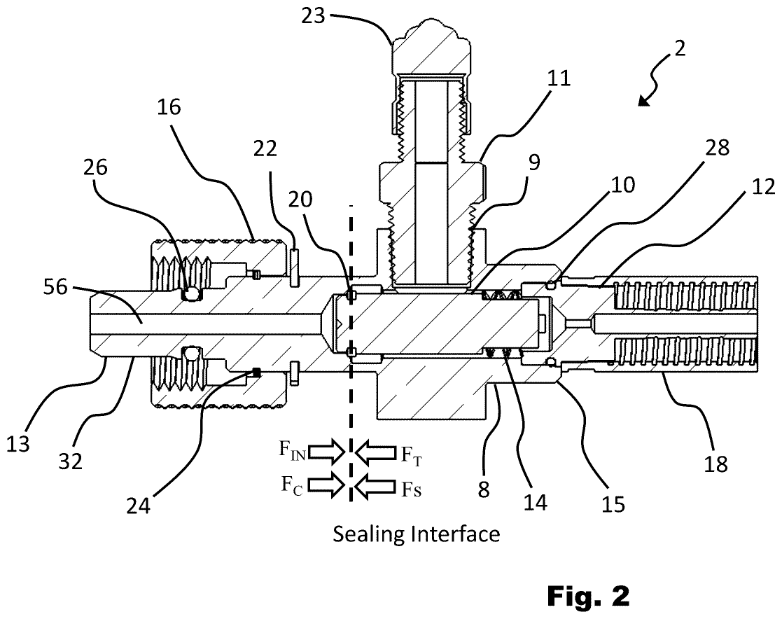

An exemplary embodiment of a tire pressure equalization system 3 including a tire pressure equalization valve 2 and an auxiliary port 9 is illustrated in FIG. 1. In the embodiment shown in FIG. 1, and as seen in more detail in FIG. 2, the auxiliary port may be positioned downstream from a valve body seal so that the auxiliary port may be placed in fluid communication with a vehicle tire. The auxiliary port, may, for example, be used for providing an external check point of tire pressure or to allow external inflation which may be useful in some situations. In some embodiments, an auxiliary port may include a pressure sensor. Although a single auxiliary port is shown the illustrated embodiment of FIG. 1 and FIG. 2, in some embodiments, more than one auxiliary port may be included. For example, a first auxiliary port may include a pressure relief valve and a second auxiliary port may include a pressure sensor.

As shown in FIG. 1, the pressure equalization system 3 may be used with an ATIS. A rotary union 4 of an ATIS may be disposed on a vehicle hubcap 6 for connection to a vehicle-mounted fluid pressure source. The rotary union 4 may, for example, provide a coupling so that a non-rotating fluid conduit may provide fluid to rotating wheels of the vehicle. The hubcap 6 may be coupled to a vehicle wheel hub on which two or more pneumatic tires are mounted. In the illustrated embodiment, the rotary union 4 comprises a pair of outlet ports 5 for routing pressurized fluid to each of an inner tire and an outer tire of a vehicle including a wheel end with dual tires. However, in other embodiments, the rotary union 4 may include other configurations of outlet ports 5 such as may be used with vehicles designed for use with different wheel end configurations or tire arrangements. The fluid conduits 7 may be used for routing fluid passing through the rotary union 4 to the vehicle tires.

A tire pressure equalization valve (TPEV) 2 may be connected to each port 5 of the rotary union 4 of an automatic tire inflation system (ATIS). For example, in some embodiments, the valves 2 may be connected to or made part of the fluid conduits 7 (e.g., air hoses) used for fluid coupling of the rotary union 4 to the vehicle tires. Advantageously, integration of the valves 2 within the fluid conduits may provide flexibility in valve positioning and simplify some aspects of valve design and operation. For example, in embodiments wherein the valve 2 is integrated within the fluid conduit 7, the inertial mass of the valve may be conveniently positioned at a significant and readily adjustable distance from the rotational axis of the vehicle wheel end so that the magnitude of the centrifugal force, which is dependent upon this distance (D) of the valve body from the axis of tire rotation, may be more readily adjusted. Accordingly, the valve 2 may, for example, be readily configured to reliably open at a desired vehicle speed, for example. This may simplify various aspects of the valve design, including, for example, selection of suitable materials for valve construction.

Alternatively, each of the valves 2 may be connected to or integrated within the rotary union 4 itself or to an attachment (e.g., a fitting or connector) directly connected thereto. For example, in the embodiment shown in FIG. 1, the valves 2 may be directly connected to the rotary union 4 via the ports 5 using a suitable adapter or connector. Accordingly, a tire pressure equalization valve 2 may be protected within the rotary union 4 or in an attachment connected thereto. Notably, risk of inadvertent loss or damage of a valve 2, such as during vehicle use or maintenance, may generally be reduced when the valve is configured in this way. For example, when mounted to the rotary union or to a connector secured thereto, the valve 2 may remain safely secured to the rotary union 4 when fluid conduits or air hoses needs to be replaced so that risk of the pressure equalization valve being inadvertently discarded during maintenance is minimized.

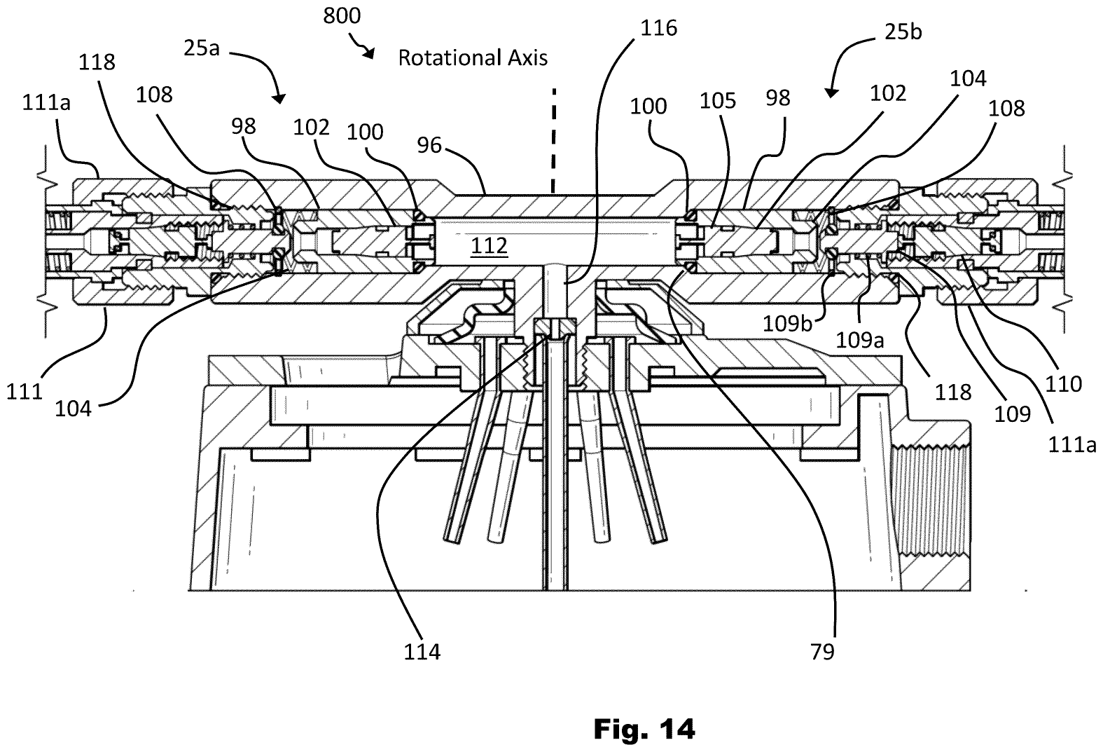

FIG. 2 shows an exemplary embodiment of the tire pressure equalization valve 2. Tire pressure equalization valve 2, as shown in FIG. 2 may, for example, be used with pressure equalization system 3. As shown therein, the valve 2 may comprise a valve housing 8, an auxiliary port 9, a valve body 10, and a valve body seal 20. The valve housing 8 generally encloses the valve body 10. Other components shown in FIG. 2, including, for example, auxiliary port fitting 11, hose fitting 12, and connector 16 may be integrated together with the valve 2. In other embodiments, one or more of those components may be removably coupled to the valve housing so that they comprise discrete components of a tire pressure equalization system 3. In some embodiments, the equalization valve 2 may be integrated together with or made part of the fluid conduit 7. For example, as shown in FIG. 20, in some embodiments, an equalization valve 2 may be secured to one end of the fluid conduit 7 so that fluid conduit and equalization valve 2 are integrated together as a conduit assembly 440. In the illustrated embodiment, the valve 2 is secured directly to the rotary union using a connector 16. However, in some embodiments, the valve 2 and the rotary union 4 may be integrated together in a common housing with the rotary union. For example, as also embodied in tire pressure equalization valve assembly 800 (shown in FIG. 14) the valve 2 may be integrated into a common housing with the rotary union 4.

The valve body seal 20 may comprise a seal packing, such as an O-ring having a round or square cross section disposed around an enclosing boundary of the valve body 10. The valve body seal 20 may be configured so that it may sealingly couple the valve body 10 to the valve housing 8. For example, as shown in FIG. 2, the valve body seal 20 may comprise a shaped packing (e.g., a square profiled O-ring) disposed about either or both of the valve body 10 or the valve housing 8 to define a sealing interface. For example, valve body seal 20 may be secured to the valve body 10 using groove 68. Alternatively, the valve body seal 20 may be secured to the valve housing 8. For example, the valve body seal 20 may be held in a groove formed within the valve housing 8.

Forces incident on the valve body 10, including, a fluid pressure force provided by an internal pressure system (FIN) (where provided by an ATIS), centrifugal force (Fc) associated with vehicle motion, a counterbalancing spring force (Fs), and a force provided by fluid pressure from the vehicle tire (Fr) are further shown therein. As further described below, in some embodiments, the relative magnitudes of those forces may be tailored for different embodiments and applications.

The valve 2 includes a first end 13 and a second end 15. The first end 13 and second end 15 of the valve 2 may sometimes be referred to herein, respectively, as the proximal and distal ends of the valve. In this terminology, the terms “proximal” and “distal” refer to the position of the two ends of the valve 2 in relation to the axis of rotation of the wheel end of a vehicle upon which the valves may be installed. For example, the proximal end 13 of the valve 2 may be connected to the rotary union 4 so that it is positioned relatively closer to the central axis of rotation of the wheel end than is the distal end 15. A connector 16 may be provided at the first end 13 of the valve for connecting the valve housing 8 to the rotary union 4. The connector 16 may, for example, comprise a swivel nut which may sometimes be referred to herein as a swivel nut adapter. In some embodiments, the connector 16 is a swivel nut which may be held in position by a first and a second snap ring 22, 24. The snap rings 22, 24 maintain positioning of the swivel nut 16 while allowing rotation of the swivel nut, thusly allowing the swivel nut to be threaded onto a male adapter of the rotary union 4. The swivel nut 16 may be tightened to reliably seal the valve 2 to the rotary union 4 using valve housing seal 26. In this embodiment, swivel nut 16 may be used to install the valve 2 easily and securely on the rotary union 4 yet still allow the valve 2 to be removed when needed.

An hose fitting 12 may be connected to the valve 2 at its distal end 15 for securing the conduit 7 (as seen in FIG. 1) thereto and for providing fluid communication to one or more vehicle tires. The fitting 12, may, for example, be a hose adapter and comprise one or more barbs such as may be useful to help secure a flexible fluid conduit 7, such as an air hose, thereto. Other suitable types of adapters may also be used, as may depend, for example, on a particular type of conduit 7 used. In some embodiments, a flexible tubing 7 may be secured to the hose adapter 12 by a ferrule 18 crimped over the tubing. A barbed adapter seal 28 may be disposed at the distal end of the barbed fitting 12 to prevent leakage of fluid from inside of the valve housing 8 to the environment. The seal 28 may, for example, be an o-ring or another suitable seal may be used.

The valve body 10 may be biased toward one end of the valve housing 8 and may be configured to slide or translate within the housing. For example, the valve body 10 may be urged towards the proximal end 13 of the valve 2 using a compressible material or spring, for example. In the embodiment shown in FIG. 2, a single spring 14 is concentrically disposed over an end of the valve body 10. In other embodiments, two or more springs 14 of different elasticity may be used to tailor a net spring force provided on the valve body 10. The valve body 10 may be held within the valve housing 8 and biased to a first or closed position. While the valve body 10 is biased to the first position, the valve body 10 may force the valve body seal 20 into engagement with the valve housing 8 to prevent fluid flow through the valve 2 in either direction. The valve body 10 may translate to a second or open position when the spring bias is overcome by a force of suitable magnitude. For example, the spring bias may be overcome by forces associated with fluid pressure, centrifugal forces, or a combination of both forces. In the open position the equalization valve 2 may provide two-way fluid flow therethrough so that fluid may be freely communicated from the rotary union 4. Thus, when both pairs of equalization valves 2 are open, two-way fluid flow may be allowed from one tire to another allowing for pressure equalization between the tires.

As described above, the valve body 10 may comprise an inertial mass that is subject to inertial or centrifugal forces (Fc) naturally induced due to wheel rotation. For example, in some embodiments, the valve body 10 may be made of a tungsten alloy. The valve housing may, for example, be comprised of brass. Notably, tungsten is sufficiently denser than some other possible materials and has interfacial properties so that it may provide relatively low and controllable frictional resistance when translating within a suitably constructed valve housing 8. Importantly, the combination of a tungsten valve body 10 and a brass valve housing 8 provides an assembly possessing well controlled thermal properties that minimize distortions in shape that may otherwise interfere with reproducible sliding engagement of the valve body and housing and change the dynamics of valve operation. In some embodiments, a valve 2 comprised of a tungsten valve body 10 and a brass valve housing 8 and otherwise configured as described herein, may open, at least when the tire is properly inflated, within a suitable range of speeds about a threshold vehicle speed (e.g., a range of about +/−10% from the threshold speed) over a temperature range from about −40° F. to about 200° F. This combination of materials also provides good corrosion resistance and affords other physical properties suitable for long term use as a valve.

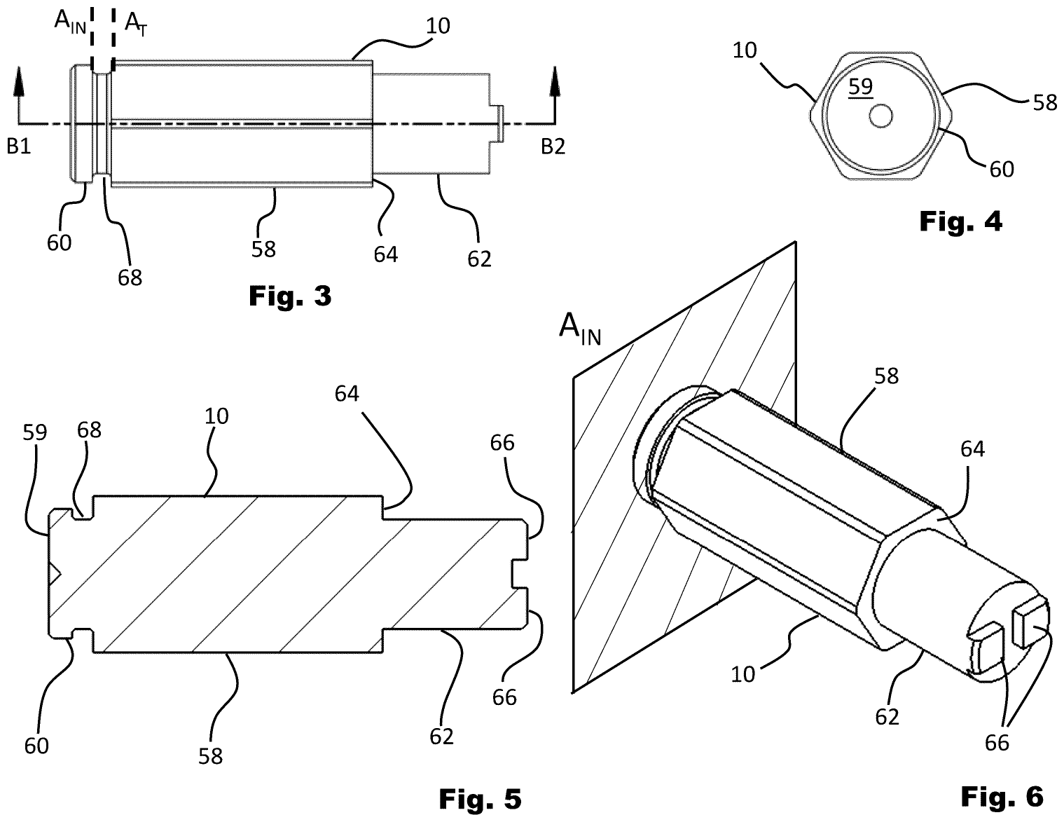

An embodiment of the valve body 10 is shown in FIGS. 3-6. As shown therein, the valve body 10 may comprise a central section 58, a sealing body 60, and a spring shaft 62. The central section may be generally hexagonal or of any other suitable geometry. A groove 68 may be formed between the central section 58 and the sealing body 60. The central section may maintain a spring bracing face 64 against which an end of the spring 14 may abut and thus creating a reaction face through which the spring force may be transferred to the valve body 10. The spring shaft 62 may, for example, be generally cylindrical, which may provide a surface upon which the spring 14 may be securely disposed concentrically over the shaft length. One or more standoff pads 66 may be disposed at the distal face of the spring shaft so as to allow the creation of a fluid conduit at its distal end when the valve body 10 translates to the second or open position. The sealing body 60 may be of a smaller diameter than the central section 58 and be able to enter the conical fluid chamber 54 therefore engaging the valve body seal and the interior wall of the conical chamber to prevent fluid communication past the conical chamber.

Pressurized fluid may be communicated from the rotary union 4 through a channel 56 (shown in FIG. 2, for example) made in the valve housing 8, thereby applying fluid pressure to the front face 59 of the valve body 10. Accordingly, fluid from an internal fluid pressure source (such as from an ATIS pressure source) may provide a net fluid pressure force (F_{IN}) that tends to push the valve body 10 to open the valve 2. As shown in FIG. 2, the force (F_{IN}) is directed in the same direction as the centrifugal force (F_{C}). The force (F_{IN}) is directed in the same direction as the centrifugal force (F_{C}) and may work with the force (F_{c}) to help to actuate or slide the valve body 10 to a second or open position. The spring 14 may provide a counterbalancing spring force (F_{S}) upon the valve body 10. The force (F_{S}) provided by the spring 14 on the valve body 10 is directed towards the rotational axis of the wheel end upon which the valve 2 is mounted. Accordingly, the spring force (F_{S}) may sometimes be herein referred to as a centripetal force. In addition to the spring force, additional forces may further be provided on the valve body due to fluid pressure provided by the tire. For example, tire pressure may provide a tire pressure force (F_{T}) directed in the same direction as the force (F_{S}). The force (F_{T}) may generally work with the spring force (F_{S}) to help keep the valve in the first or closed position.

When either of, or in combination of, the radially outwardly directed forces (F_{IN}, F_{C}) are greater than the counterbalancing forces (F_{T}, F_{S}) then the valve body 10 may translate from the first position to a second position in the valve housing 8. The translation of the valve body 10 in the valve housing 8 may open the valve 2 allowing for communication of pressurized fluids between any tires interconnected by the valves 2. For example, translation of the valve body 2 to its secondary position may enable fluid communication through the channel formed between the valve body 10 and the valve housing 8, thereby allowing for equalization of pressure amongst all tires connected by the rotary union (e.g., the inner and outer tires mounted on a dual wheel connected through the rotary union 4). That is, fluid may flow from a tire having higher pressure through the rotary union to a tire having lower pressure. Thus, the system may maintain tires at a minimum fluid pressure whether the vehicle is stopped or moving, and may further allow tire pressure equalization when the vehicle is moving above a threshold speed. Furthermore, when the fluid source provides fluid at a pressure lower than the tire pressure or fails to provide fluid, then tire pressure may prevent the valve body 10 from opening. That is, the tire pressure will prevent the valve body 10 from translating from the first (closed) position to a second (open) position. In some embodiments, the equalization valve may be configured to remain closed under tire pressure even when the vehicle speed exceeds the threshold at which the valve would open if the centrifugal force on the valve body was supplemented by fluid pressure from an ATIS fluid pressure source.

Generally, the forces (F_{IN}, F_{T}) may be related to the cross-sectional area at the relevant sealing interfaces. With reference to FIG. 6, an inflation side sealing interface may generally be disposed at the position A_{IN}. Likewise, a tire side sealing interface may generally be disposed at the position A_{T}. The forces (F_{IN}, F_{T}) may be the same or different depending upon the size and relative geometry of the valve body 10 and the valve housing 8 on either side of the groove 68 in which the valve body seal 20 is disposed. With further reference to FIG. 3, the cross-sectional area at the inflation system side of the valve 2 may sometimes be referred to as the surface area of the inflation system side seal (A_{IN}). The cross-sectional area at the tire side of the valve 2 may sometimes be referred to as the surface area of the tire side seal (A_{T}). In some embodiments, the size and shape of the valve body 10 and/or valve housing 8 at the sealing interfaces, position of the center of mass of the valve body 10, mass of the valve body 10, and/or other features of the valve 2 as described herein may be adjusted to help set one or more operating characteristics of the valve 2. For example, operating characteristics of the valve 2 may include, for example, a threshold vehicle speed at which the valve 2 is designed to open (e.g., when other forces on the valve are balanced or within normal specification limits), and variations in the threshold vehicle speed at which the valve 2 is designed to open when other forces (e.g., forces based on fluid pressure) are out of balance.

In some embodiments, relative contributions to the threshold force necessary to open the valve that is based on fluid pressure or on naturally induced centrifugal directed forces may be modified to change one or more operating characteristics of the valve 2. For example, generally, by increasing the cross-sectional area of the inflation system side seal (A_{IN}), the contribution to the overall force for opening the valve based on internal pressure may be increased. In contrast, by decreasing the area (A_{IN}) the contribution to the overall force for opening the valve based on internal pressure may be decreased. Likewise, adjusting the cross-sectional area of the tire side seal (A_{T}) may change the contribution of tire pressure towards a biasing force tending to hold the valve closed. In some embodiments, forces due to inflation side and tire side fluid pressure may be significant and about balanced when a vehicle tire is correctly inflated. In some embodiments, the forces (F_{IN}, F_{T}) may be relatively greater than the forces (F_{C}, F_{S}) even at speeds at which the valve 2 opens. Accordingly, in some embodiments described herein, if the fluid pressure source cannot maintain sufficient fluid pressure at the inflation side of the seal (so that F_{IN} drops) then the valve 2 may remain sealed or close even if the vehicle is travelling above a speed at which centrifugal forces would normally open the valve. Thus, in some embodiments, the valve 2 may generally allow two-way fluid flow so as to provide equalization between tires when a vehicle is in motion and operating normally. However, the valve 2 may automatically close in the event of a severe leak wherein isolation of one tire from another may be advantageous. In some embodiments, an area (A_{IN}) may be about 0.05 square inches to about 0.15 square inches. In some embodiments, the area (A_{T}) may be comparable to or slightly less than the area (A_{IN}). For example, in some embodiments, a ratio of areas (A_{IN}) to (A_{T}) may be about 0.7 to about 1.0,about 0.75 to about 0.98, or about 0.85 to about 0.95.

In some embodiments, the valve 2 may be configured to transition from a closed state to an open state when the vehicle is travelling at speeds of at least about 40 miles per hour to at least about 60 miles per hour. In some embodiments, the valve 2 may be configured to transition from a closed state to an open state at highway speeds even if the center of mass of the valve body 10 is positioned within about 1 inch to about 5 inches from the rotational axis of a wheel upon which the valve body 10 is mounted. This may be advantageous because the valve 2 may then be integrated with the rotary union 4 or positioned closely thereto and held in a more protected area than may otherwise be realized if the valve were displaced away from the rotary union 4 (such as if the valves 2 were disposed in air hoses such that the center of mass of the valve body was positioned further away from the rotation axis of the wheel end upon which the valve is mounted, such as at or near the tire valves). In some embodiments, the relative surface areas (A_{IN}, A_{T}) may be configured so that the cross-sectional area of the inflation side seal is about equal to the cross-sectional area of the tire side seal. For example, the areas may be selected so that the opposing forces (F_{IN}) and (F_{T}) have similar surface areas. In one embodiment, a square profile O-ring and an approximately 45 degree sealing surface 79 (shown in FIG. 8, for example) may be used to control a pressure differential across the seal formed by an O-ring at the sealing surface. A square profile O-ring may be used with a variety of suitable sealing surface angles. Notably, in some embodiments, a square profiled O-ring or other suitably shaped seal packing may be used in place of a standard O-ring (e.g., an O-ring with a circular profile). For example, a square profiled O-ring may deform considerably less than an O-ring with a circularly shaped profile so that variations in forces related to the ratio of (A_{IN}) to (A) may be minimized. In other embodiments, the valve body seal 20 may be disposed in an inner circumference of the valve housing 8, and the valve body 10 may be provided with a tapered surface against which the valve body seal may rest to form a sealing interface. In yet other embodiments, the sealing interface may be provided by metal-to-metal or metal-to-graphite components. For example, in some embodiments, a precision ground or machined metal-to-metal, metal-to-fluoropolymer, or metal-to-graphite contact may be used to provide a sealing interface.

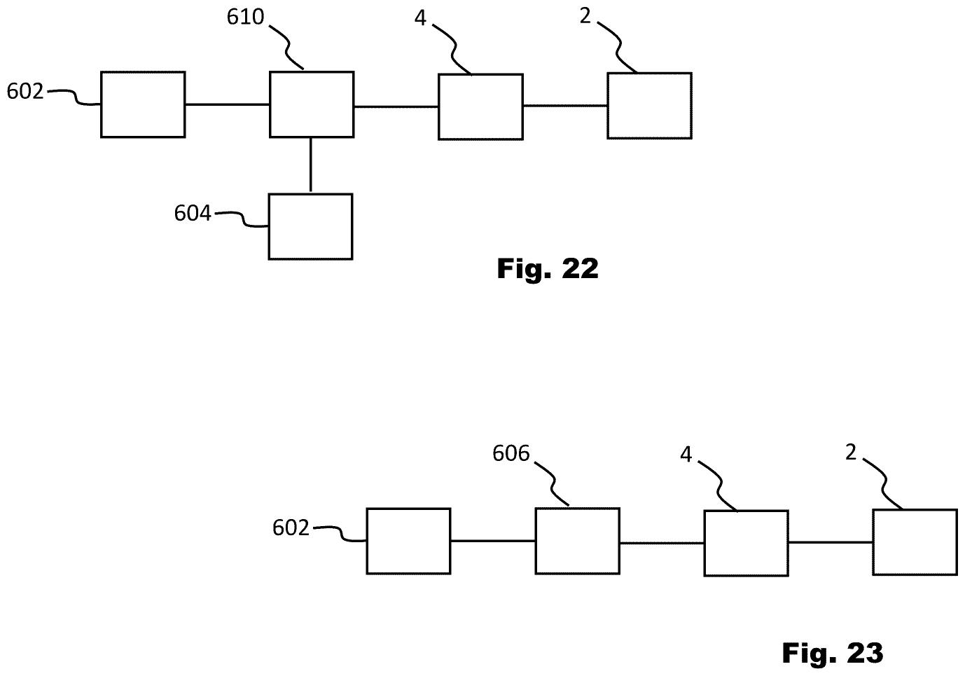

In some embodiments, an ATIS system may incorporate a rotary union 4 and an internal pressure source (not shown) without an intermediary check valve therebetween. In such systems, tire pressure deflation may be enabled by allowing excess fluid pressure to back flow through the valve 2. This two-way flow allows for tire pressure equalization to occur all while being regulated by the set inflation system pressure. In some such embodiments, as shown in FIG. 22, for example, a pressure regulator 610 may be installed between the pressure source 602 and the rotary union 4. This regulator may, for example, be equipped with a vent 604 or other means for relieving system pressure communicated thereto from an over inflated tire. In some embodiments, as shown in FIG. 23, an electronic control box 606 may be installed between a pressure source 602 and the rotary union 4. The electronic control box 606 or pressure-relieving pressure regulator may be configured to relieve excess fluid pressure communicated from an overinflated tire. Advantageously, in such embodiments, control of both deflation and inflation may be achieved using centralized system components. This may allow for more accurate pressure equalization among a plurality of tires, such as among all tires on a trailer. For example, any number of wheels and associated tires may placed in two-way communication with a pressure regulator 610 and/or electronic control box 606 as described herein. Therefore, those wheels and associated tires may be regulated together so that pressure equalization does not depend, for example, on independently configured valves (e.g., check valves, relief valves, or diaphragm valves) as may be relied upon in some prior art systems. For example, equalization pressure may be achieved within a sealed axle connected between opposite wheel ends or between multiple interconnected wheel ends depending on the internal fluid connections of the inflation system.

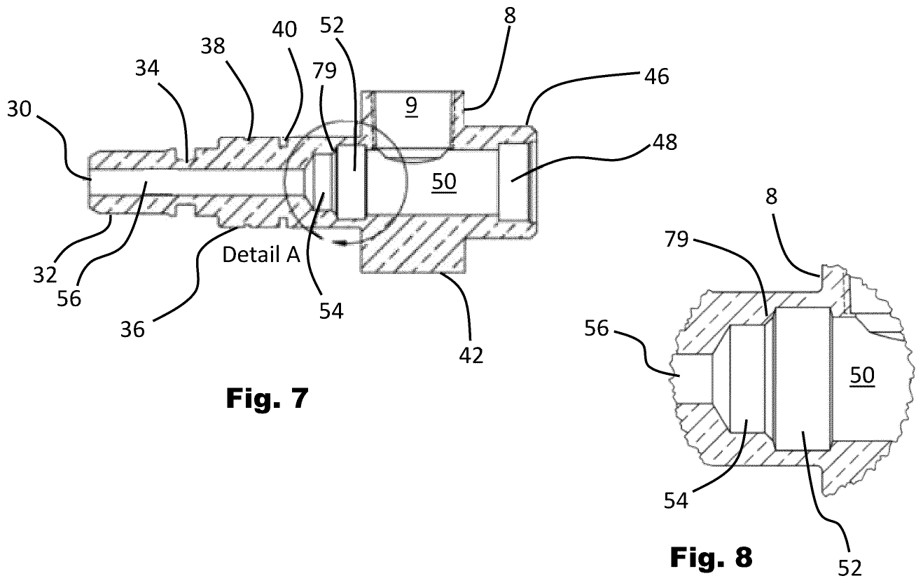

An embodiment of the valve housing 8 is also shown in FIGS. 7 and 8. FIG. 8 provides further detail (Detail A) of features shown in FIG. 7. With reference to FIG. 2, the valve housing 8 may comprise structure to which other components and features of the valve are disposed. In the embodiment shown in FIG. 7 and FIG. 8, the valve housing 8 may include a first cylindrical portion 32, a second cylindrical portion 36, a central section 42, and a third cylindrical portion 46. In some embodiments, the valve housing 8 may be shaped differently depending, for example, on the shape of the valve body 10 and the desired characteristics of the valve 2.

At a proximal end of the valve housing 8 (i.e., the end positioned nearest the rotary union 4), the valve housing 8 may comprise first cylindrical portion 32. The first cylindrical portion 32 of the housing may comprise a length that at least part determines the distance (D) of the valve body 10 from the rotation axis. For example, as shown in FIG. 1 and FIG. 2, the valve housing 8 may include an extended first cylindrical potion 32 so that the sealing interface is generally positioned away from the rotational axis of the wheel end but still integrated together with the rotary union or an attachment connected thereto. An annular groove 34 may be disposed in the first cylindrical portion 32. The annular groove 34 may be shaped to accept and securely hold a valve housing seal 26 (shown in FIG. 2, for example). The second cylindrical portion 36 may be disposed adjacent to or along the first cylindrical portion 32. Second and third annular grooves 38, 40 may be disposed therein to accept the first and second snap rings 22, 24 for retaining the connector 16 (e.g., swivel nut or another connector) thereto. The central section 42 may be disposed adjacent to the second cylindrical portion 36. An auxiliary port 9 may be disposed in an end of the central section 42. For example, the auxiliary port 9 may be disposed generally normal to the longitudinal axis of the cylindrical portions 32, 36. The auxiliary port 9 may, for example, be disposed on the tire side of the scaling interface of the valve 2, which is defined by the valve body seal 20. In some embodiments, the valve housing 8 may enable fluid flow from a connected vehicle tire to the auxiliary port 9 so that a tire pressure may be checked manually or so that the tire may be filled manually through the auxiliary port. The third cylindrical portion 46 may be positioned adjacent to the central section 42. The valve housing 8 may further include a first port 30 and a second port 48. The first port 30 may, for example, receive fluid pressure from a pressure source through the rotary union 4 when a vehicle tire is underinflated. The second port 48 may disposed within the third cylindrical portion 36 in a manner coaxial to the first, second, and third cylindrical portions.

An internal fluid communication network may thus be formed within the valve housing 8. For example, fluid may be communicated between the ports 30, 48 through the fluid chambers 50, 52, 54, and 56 of the channel. A first fluid communication chamber 50 through the central section 42 and third portion 46 may originate at the second port 48 and terminate at a first fluid chamber 52. The first fluid chamber may be adjacent to a conical fluid chamber 54. Originating at the small diameter end of the conical chamber may be a second fluid communication chamber 56. The second channel may then terminate at the distal end the first cylindrical portion 32. The internal fluid communications channel is thus formed between the distal end, the proximal end, and the auxiliary port 9. The auxiliary port 9 may be an auxiliary port for the disposition of secondary components such as a tire filling adapter or tire pressure check valve, pressure relief device, or other devices that may be of need for the user.

For example, in some embodiments, the auxiliary port 9 may comprise a tire filling adapter. The tire filling adapter may, for example, allow a user to connect a vehicle tire to an external inflation system or enable a user to externally verify the pressure of the one or more tires. In some embodiments, the auxiliary port 9 may comprise a pressure relief valve enabling the system to vent external pressure from a vehicle tire. For example, in some embodiments, the pressure relief valve may be formed within a cap 23 of fitting 11, which may be disposed within the port 44. Removal of the cap may provide access for inflation of a vehicle tire. When the cap is tightened on the port 44, the pressure relief valve may be enabled. The pressure relief valve may, for example, be calibrated so that it will release excess pressure from a tire that might otherwise interfere with opening of the valve 2. For example, the pressure relief valve may be designed to relieve pressure when a tire is inflated to a level that is more than about 10% to about 25% greater than a specified vehicle tire pressure. This would, for example, facilitate reliable opening of the valve 2 at a desired speed even in embodiments herein wherein a cross-sectional area of the tire side seal is significant and where tire side pressure may be purposefully designed to work with a spring force to counterbalance centrifugal directed forces. In some of those embodiments, the relief valve would not be tasked with perfectly balancing a vehicle tire with other vehicle tires. That role could still be fulfilled by a central or common regulation source so as to promote more reliable pressure balancing between tires. However, the pressure relief valve may, for example, be designed to relieve excess fluid pressure so that a threshold vehicle speed at which the valve 2 is designed to open will vary be no more than about 10% even if a tire has become slightly overinflated (e.g., due to exposure to light and heating) when the vehicle is at rest.

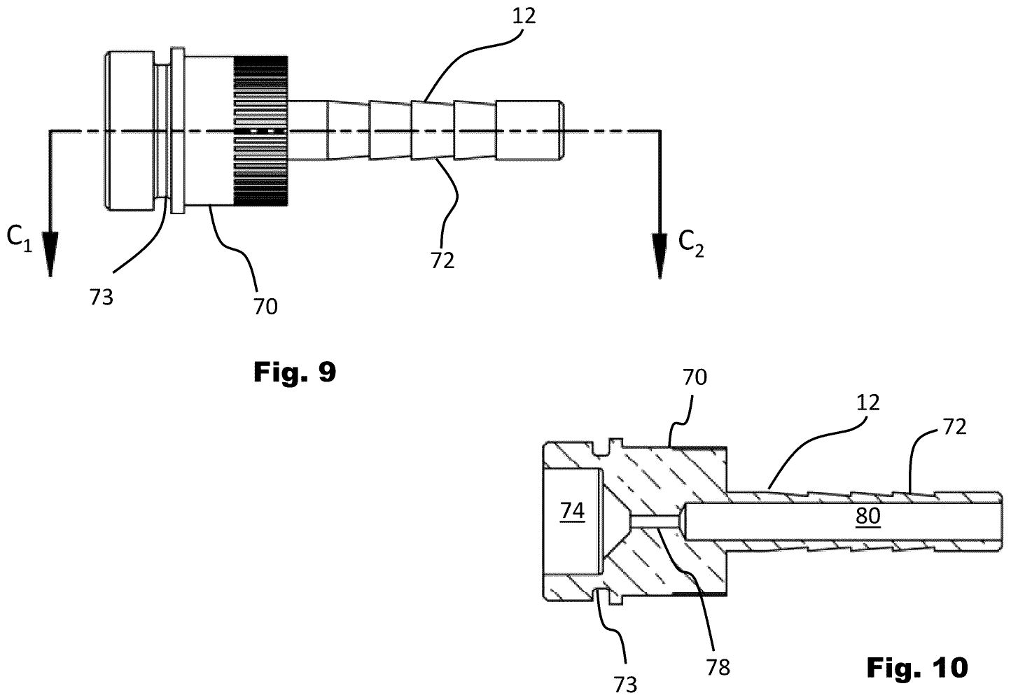

An embodiment of the barbed hose adapter 12 is further shown in FIG. 9 and FIG. 10. FIG. 10 provides a view of Section C-C of FIG. 9. As shown therein, the fitting 12 may comprise a fitting body 70 and a barbed cylinder 72. An annular groove 73 may be disposed about the fitting body to accept the fitting seal 28. A fluid port 74 may be disposed at the inboard end of the fitting body and for fluid communication with fluid chamber 50 (FIG. 7) when the fitting 12 is coupled to the valve housing. A fluid communication channel 78 may pneumatically join fluid port 74 and fluid channel 80 that extends through the barbed cylinder 70. The smaller diameter channel 78 may restrict fluid flow so as to reduce the likelihood that a blowout in one tire in an dual tire set will result in sudden deflation of the second tire of the set.

In some embodiments, a metering device 600 (shown in FIG. 21) may be integrated within or positioned before the fitting adapter 12, such as in fluid channel 78. A metering device 600 may, for example, allow a higher flow rate in a direction into the tire, and a lower flow rate out of the tire. This feature may be useful to ensure that air can enter into a tire faster than air can leave the tire. Accordingly, in the event a tire develops a leak greater than an ATIS system can counteract, a metering device will prevent other tires from rapidly deflating when one tire suffers a blowout or severe damage.

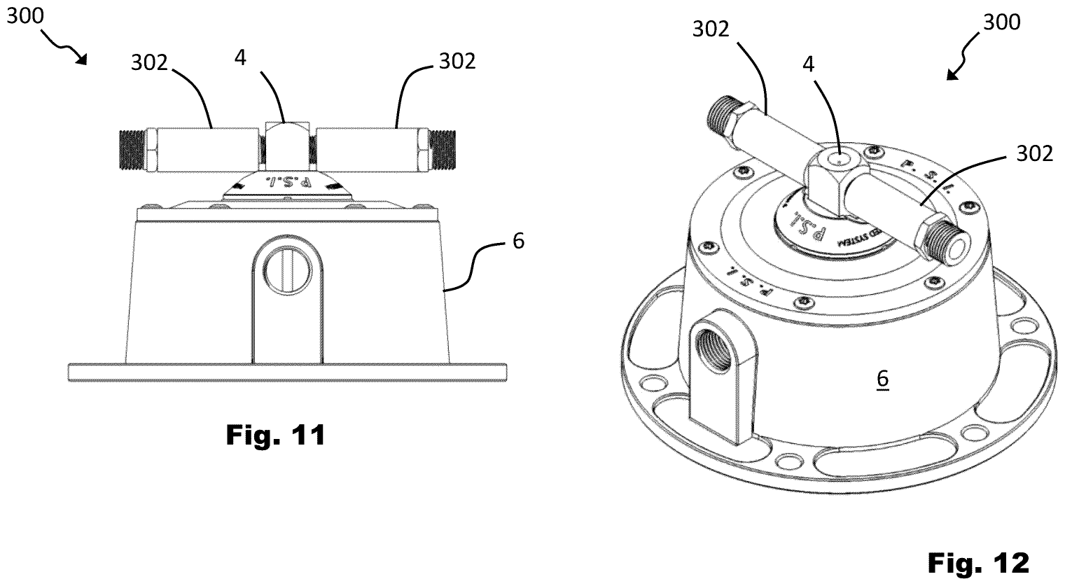

Another exemplary embodiment of a tire pressure regulation system 300 for automatic vehicle tire pressure monitoring is illustrated in FIG. 11 and FIG. 12. As shown therein, in some embodiments, a pair of ATIS compatible valves 302 may be connected to the rotary union 4. For example, the valves 302 may be connected to the rotary union 4 by threaded means. Alternatively, in the absence of an ATIS, the valves 302 may be connected to a post extending from the hubcap. The post may, simply provide a channel for connecting the valves 302 together so that the valve may simply allow for two flow and pressure equalization between tires when a vehicle is moving above a threshold speed.

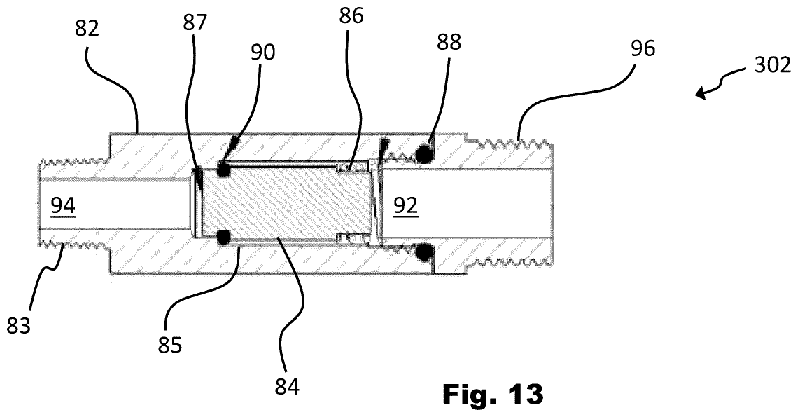

An embodiment of the valve 302 is shown in FIG. 13. As shown therein, a valve 302 may comprise a housing 82, valve body 84, spring 86, first seal 88, second seal 90, fluid port 92, and fluid channel 94. The housing 82 may be generally cylindrical with a threaded portion 83 at one end to serve as an ATIS connection. The port 92 may be disposed at the other end of the housing 82. The port 92 may accept a threaded hose fitting 96 to mate with an air hose for fluid communication, for example. The first seal 88 may be disposed at the interior wall of the port 92 to form a sealing connection between the housing 82 and the hose fitting 96. The housing 82 may include a valve body chamber 85 adjacent to the fluid channel 94. The valve body chamber may be of a stepped diameter configuration at the end near to the small diameter threaded cylinder of the housing. The valve body 84 may be a cylinder wherein each end is stepped down to a smaller diameter than the central region. The second seal 90 may be disposed at the end of the the valve body nearest the ATIS connection, and serves to seal the valve body 84 to the valve housing 82. A spring 86 disposed between the valve body 84 and the hose fitting 96 urges the valve body toward a first sealing position with respect to the valve housing 82. When the valve body 84 translates in the valve housing 82 to a second, open position, then pressurized fluid may flow past the face 87 of the valve body and around the valve body 84.

In some embodiments, a system of valves or valve assembly may be included in a tire pressure equalization system. For example, in FIG. 14, an embodiment of a tire pressure equalization valve assembly 200 is shown. The equalization valve assembly 200 comprises a common housing 96 for housing a plurality of valves. In some embodiments, the valve assembly 200 may integrated together with a rotary union or part of a rotary union. For example, in some embodiments, the valve assembly 200 may be pneumatically coupled to a tubular member 114 of a rotary union. In some embodiments, the housing 96 may comprise a plurality of arms to provide fluid communication with different vehicle tires. For example, in the embodiment shown in FIG. 14, the housing 96 may comprise two arms extending outwardly from the rotational axis of the wheel so as to direct fluid towards each of an inner tire and an outer tire which may be connected thereto. The housing 96 may thus form a tee body of a rotary union. The arms may comprise separate valves 25a, 25b for controlling fluid flow therethrough. For example, each of the valves 25a, 25b may comprise a valve body 98, first seal 100, internal check valve 102, and spring 104. A snap ring 108 may be used to retain the spring and valve body 98 in the housing 96. A threaded port 118 may be coupled to the housing 96 by means of a swivel nut 111a to permit coupling of an air hose thereto. In some embodiments, the threaded port 118 may include a one-way check valve 109 disposed within the threaded port 118 and oriented to prevent pressurized fluid from escaping the rotary union when a fluid hose fitting 103 is disconnected from the threaded port 118 by disengaging a swivel nut 111a. When the fluid hose fitting 103 is disconnected from the threaded port 118, a spring 109a holds the check valve 109 closed. In the closed position, a valve seal 109b may seat in in the threaded port 118. When the fluid hose fitting 103 is coupled to the threaded port 118, the post 103a of the fluid hose fitting 103 engages the check valve 109, thereby holding it open. In some embodiments, the check valve 109 may simultaneously engage and hold open an air hose check valve 110 when coupled to an air hose 111 having such a check valve. In other embodiments, the air hose check valve 110 may open under fluid pressure imbalance across the air hose check valve 110. The housing body 96 may integrate the valves together by providing a central fluid chamber 112 formed therein which may serve as a common inlet for the valves 25a, 25b.

In some embodiments the central fluid chamber 112 may be connected to a rotary union tubular member 114 via the fluid channel 116. The rotary union tubular member 114, fluid channel 116 and central fluid channel 112 may be in scaled fluid communication with a vehicle fluid pressure source (not shown in FIG. 14) of an ATIS. The central fluid chamber 112 may be of a suitable diameter at its outer ends so as to accept components disposed therein (e.g., valve body, seals, spring, and a threaded port assembly).

Each of the arms may comprise a valve body 98 having a longitudinal channel 105 disposed therein. In one embodiment, a normally-closed check valve 102 may reside within the longitudinal channel 105. The internal check valve 102 may, for example, open when tire pressure is lower than pressure from the pressurized fluid source. The check valve may allow the ATIS to provide fluid to a tire even when the valve body 98 is in a first (closed) position. Thus, the check valve 102 may enable flow based solely on a pressure differential between the ATIS side of the valve and the tire side of the valve. Notably, this configuration may also enable significantly enhanced flow capacity of the pressure equalization valve. This may be noticeably contrasted with other valves wherein fluid must pass through or around an inertial body to inflate a vehicle tire. For example, when both the check valve 102 and the valve body 98 are opened, a majority of fluid flow may traverse the check valve 102 as opposed to traversing through any opening formed when the valve body 98 is translated from an open to a close state. At the inboard end of each of the valve bodies 98 a first seal 100 may be disposed. The first seal 100 may be an O-ring or other form of mechanical seal. For example, in some embodiments, the first seal 100 may comprise an O-ring with a square profiled cross section. As described above, a square profiled O-ring may be useful because a square profiled O-ring may deform considerably less than an O-ring with a circularly shaped profile so that variations in forces related to the ratio of (A_{IN}) to (A_{T}) may be minimized. In some embodiments, a square profile O-ring and 45 degree sealing surface 79 may be used to control a pressure differential across the sealing interface.

The valve body 98 may maintain an area of reduced diameter at their outboard ends so as to concentrically accept the spring 104. The spring may maintain the valve body 98 in a first (closed) position unless centrifugally directed forces (e.g., those generated by tire rotation and internal inflation system pressure) are able to overcome a force provide by the spring 98 and any forces otherwise supplied from the tire pressure.

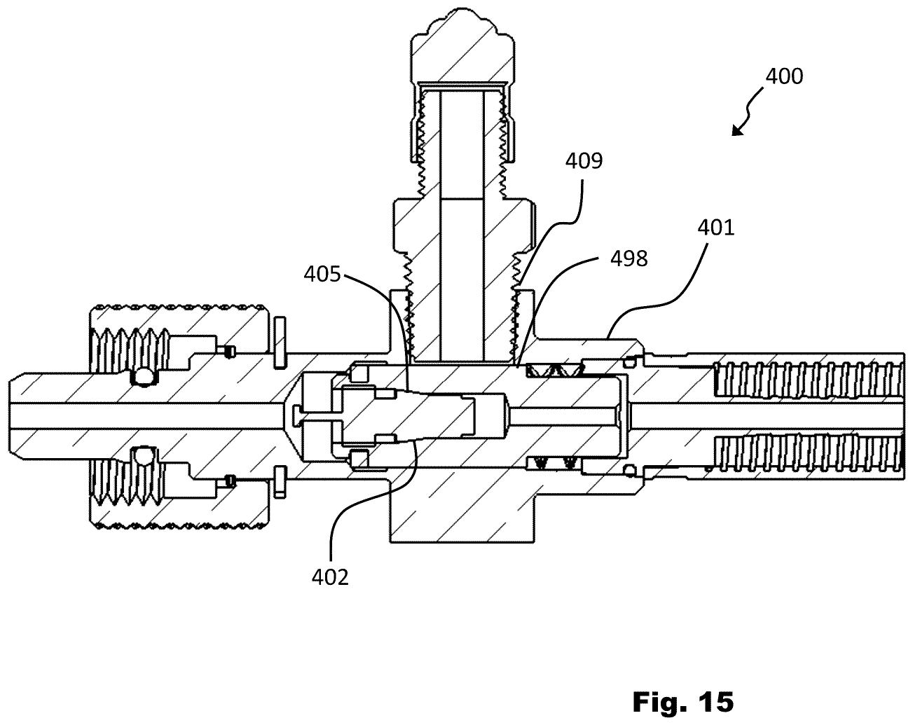

Another embodiment of a tire pressure equalization valve 400 is shown in FIG. 15. As shown therein, the valve 400 may comprise a valve body 498 having a longitudinal channel 405 disposed therein. A normally-closed check valve 402 may reside within the longitudinal channel 405. The check valve 402 may, for example, open when tire pressure is lower than pressure from the pressurized fluid source. The check valve 402 may allow the ATIS to provide fluid to a tire even when the valve body 498 is in a first (closed) position. Thus, the check valve 402 may enable flow based solely on a pressure differential between the ATIS side of the valve and the tire side of the valve. This configuration may enable significantly enhanced flow capacity over other inertial valves. In some embodiments, the valve 400 may include a housing 401 including a port 409 optionally formed therein. The port 409 may, for example, be an auxiliary port for the disposition of secondary components such as a tire filling adapter, pressure relief device, outlet for external verification of tire pressure, or other devices that may be of need for the user. In some embodiments, as similarly described above, in relation to FIG. 2, the port 409 may include a pressure relief valve configured to minimize a force supplied on the valve body by fluid pressure on the tire side of said valve so as to enable the valve to open within a threshold range of vehicle speeds even if the tire is over pressurized when the vehicle begins moving. For example, a pressure relief valve may, in some embodiments, be specified to relieve inflation pressure from the vehicle tire when the vehicle tire is inflated to a level that is more than about 10% to about 25% greater than a specified vehicle tire pressure.

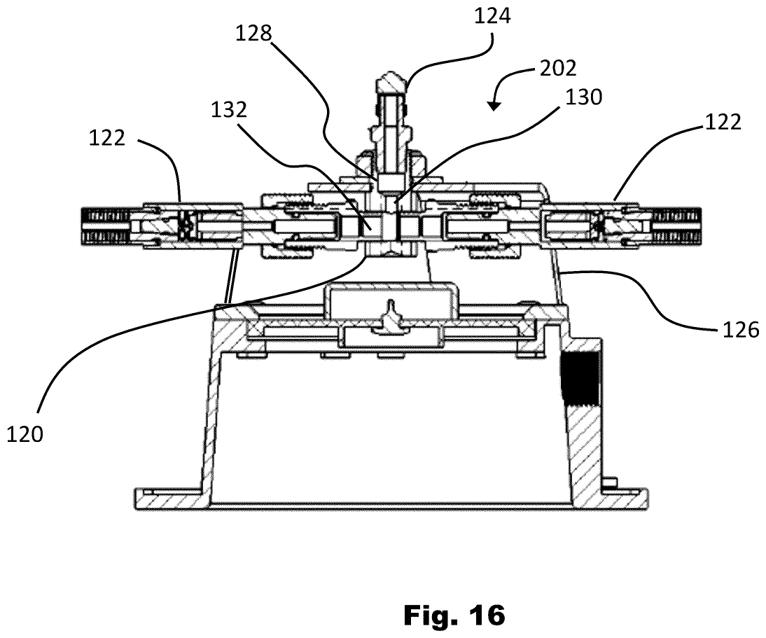

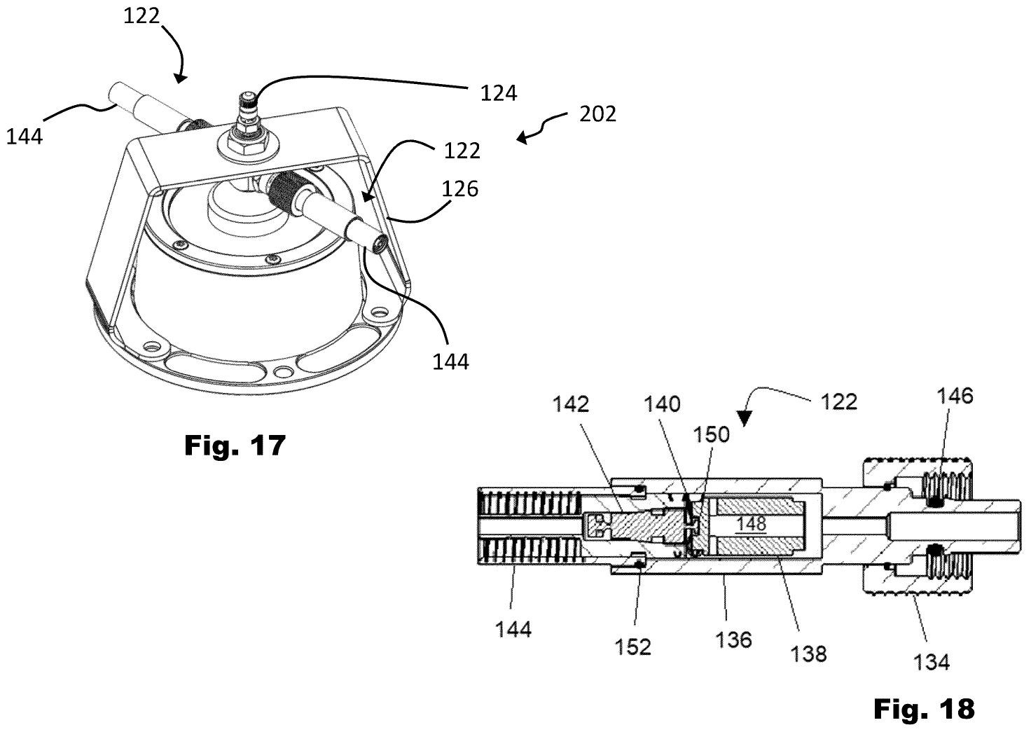

In some embodiments, a valve or valve assembly may be configured for use without an ATIS. For example, as illustrated in FIGS. 16-18, the valve assembly 202 may comprise a manifold body 120 and two or more pressure equalization valves 122 coupled thereto. A manifold body 120 may be mounted to the hubcap by a bracket 126, as seen more clearly in FIG. 17. The manifold body 120 may further comprise an auxiliary port 124. The manifold body 120 may accept an auxiliary port 124 at an orifice 128 such that the auxiliary port engages a transverse fluid channel 130. The transverse channel is pneumatically connected to a longitudinal channel 132. The longitudinal channel allows fluid communication between the fill port, flow control assemblies, and ultimately between the tires attached to the valve assembly.

In the embodiment of FIGS. 16 and 17, each pressure equalization valve 122 may be disposed at the end of an air hose (not shown) coupling the manifold body 120 to the vehicle tires (not shown). In other embodiments, the pressure equalization valves 122 may be integrated into the manifold body 120. A pressure equalization valve 122 may be removably connected to the manifold body 120. For example, as shown in FIG. 18, a pressure equalization valve 122 may comprise a swivel nut 134, valve housing 136, valve body 138, spring 140, check valve 142, and hose fitting 144. The swivel nut 134 may cooperate with the housing 136 in a manner such that the swivel rotates in relation to the manifold body 120. Such rotation allows the swivel nut to threadably connect the pressure equalization valve to the manifold body 120 to form a sealed connection. An annular seal 146 may be disposed the housing 136 such that said seal is disposed inside the region encompassed by the swivel nut. Such a seal may be an o-ring or other form of mechanical seal.

The valve body 138 may comprise an internal mass subject to centrifugal forces when the valve body is positioned at a distance away from a rotational axis and subjected to circular wheel motion during vehicle travel. The valve body 138 may be being configured for actuating a check valve in response to centrifugal forces generated by the circular motion. For example, the valve body may be a generally cylindrical mass with stepped regions at each end so as form a shoulder at each of the ends. A longitudinal fluid channel 148 extends at least partway through the valve body. A center detent 150 may be disposed on the outboard face of the valve body so as to interact with the plunger of the check valve 142. A spring 140 may be concentrically disposed at the outboard shoulder on the valve body 140 and an interior wall of the housing body 136. The spring may apply biasing force to the valve body 138 so as to urge said valve body to a normally closed position. Centrifugal forces generated by the rotation of the tire may then translate the valve body to a second, open position and thereby depressing the plunger on the check valve 142. Thus, the plunger forces the check open to allow fluid communication between any attached tires. In other embodiments, the valve body 138 need not engage the check valve 142. In such embodiment, the check valve 142 may open under fluid pressure when the valve body 138 has translated from its closed position. Alternately, attaching a pressurized source to the auxiliary port may generate pressure force against the valve body adequate to translate the valve body to the open position and allow fluid communication between said source and any attached tires. A second seal 152 may be disposed near or adjacent to the inboard end of the hose fitting 144 so that there is a scalable connection between the fitting and housing 136.

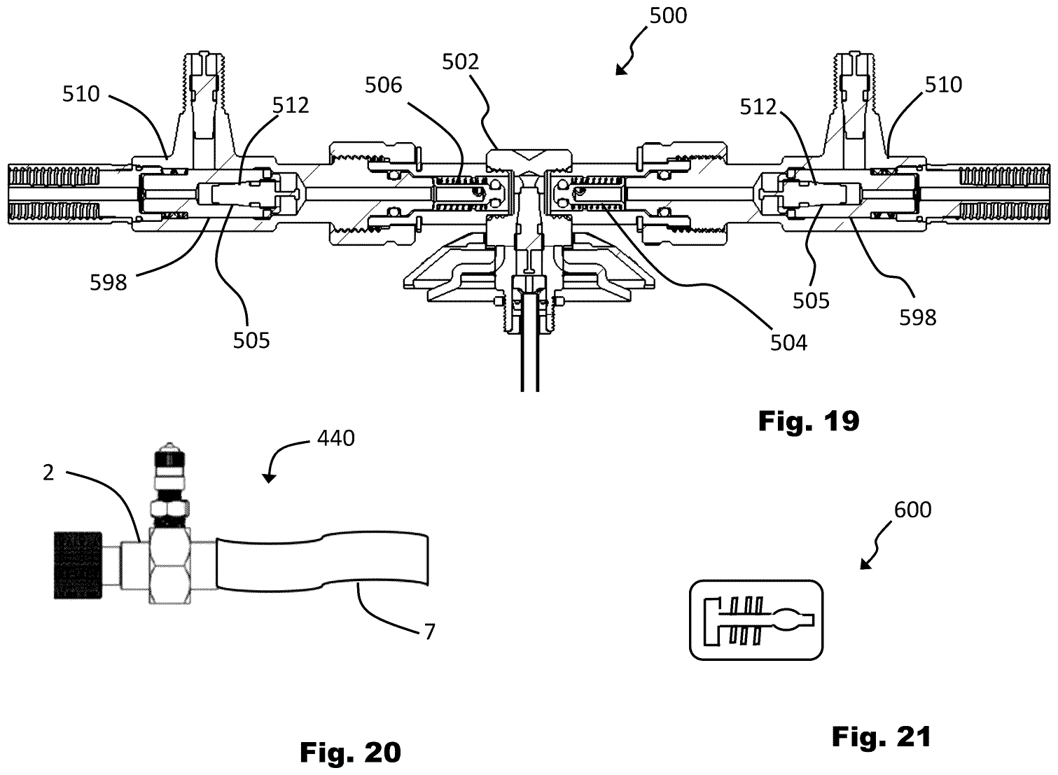

In some embodiments, a hose fitting including a pressure equalization valve installed into a through tee assembly including a centralized check valve. For example, as shown in FIG. 19, a pressure equalization system 500 is shown. Pressure equalization system 500 includes a tee body assembly 502 including centralized check valves 504, 506. A pair of pressure equalization valves 510 may be included on each of a pair of arms extending from the tee body assembly. Each of the pressure equalization valves 510 may comprise a valve body 598 having a longitudinal channel 505 disposed therein. A normally-closed check valve 512 may be disposed within the longitudinal channel 505. The check valve 512 may, for example, open when tire pressure is lower than pressure from the pressurized fluid source. The check valve 512 may allow the ATIS to provide fluid to a tire even when the valve body 598 is in a first (closed) position. Thus, the check valve 512 may enable flow based solely on a pressure differential between the ATIS side of the valve and the tire side of the valve.

In some embodiments, as shown in FIG. 21, a metering device 600 may be provided. The metering device may, for example, be positioned after the inertial valve. The metering device may operate independently of rotation. The metering device assists in closing the inertial valve if the draw from deflation exceeds a threshold flow rate.

Under normal operating conditions, only a low flow rate is required for equalization between tires and for the venting off of any excess pressure in tires since a minimal amount of air is being redistributed. In the event of a tire blow out, the other tires coupled to the system will still try and equalize with the blown out tire. As this is occurring, the flow rate of deflation will be high because one of the tires is venting directly to atmosphere. The metering device then essentially syphons off the flow of air and thus creates a large differential between either side of the inertial valve which causes the inertial valve to close even while the wheel is rotating at speed.

The pressure equalization valves may thus be used to regulate tire pressure in a variety of circumstances. When used without an ATIS, the pressure equalization valves may open when the vehicle reaches a threshold speed and allow fluid between tires to equalize. Thus, for example, in a circumstance in which pressure in an outer tire is higher than the tire pressure in an inner tir due to sitting in the sun, the pressure equalization valves will open at higher travel (e.g., highway speeds) to permit equalization of pressure between the inner and outer tires. If one or more pressure relief valves are used, then excess tire pressure may be released to atmosphere, even before the pressure equalization valves open, thus permitting tire pressure equalization closer to a desired tire pressure.

When used with an ATIS, the pressure equalization valves may open when the vehicle reaches a threshold speed and allow fluid between tires to equalize. If the tires equalize to a pressure below the desired tire pressure, then the ATIS will provide fluid to bring the tire pressure back up to the desired tire pressure. Similarly, if one tire is leaking and tire equalized pressure drops below a desired tire pressure, the ATIS will provide fluid to bring the tire pressure back up to the desired tire pressure. If one or more pressure relief valves are used, then excess tire pressure may be released to atmosphere, even before the pressure equalization valves open, thus permitting tire pressure equalization closer to a desired tire pressure. Thus, the pressure relief valves may prevent tire over-pressurization, and the ATIS may prevent tire under-pressurization, thereby maintaining the tires at or very close to the desired tire pressure, thereby increasing the life of the tires.

It should be understood that various changes, substitutions, and alterations can be made herein without departing from the invention as defined by the appended claims. Moreover, the scope of the present application is not intended to be limited to the particular embodiments of the process, machine, manufacture, composition, or matter, means, methods and steps described in the specification. In some parts of this disclosure description may be made concerning a valve, valve system, pressure equalization system, or to a method. It should be understood that where description is made to a device or system, use of those component(s) in a method may be inferred. Likewise, where description is made of a method, a device or system associated with the relevant component(s) is also envisioned. In other words, the particular class (e.g., method or system) used to describe an embodiment should be taken as exemplary and not limiting. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes. machines, manufacture, compositions of matter, means, methods, systems, or steps.

What is claimed is:

1. A vehicle tire pressure regulation system configured for mounting to a vehicle hubcap at a wheel end of a vehicle including a rotational axis, the tire pressure regulation system comprising:
a rotary union positioned along a path of sealed fluid communication including a source of pressurized fluid, a first vehicle tire, and a second vehicle tire;
a first valve configured for controlling two-way fluid communication between said rotary union and said first vehicle tire, the valve comprising:
a valve housing;
a valve body enclosed within said valve housing, the valve body comprising an inertial mass subject to centrifugal forces when the valve body is positioned at a distance away from said rotational axis and subjected to centrifugal forces when the vehicle is in motion, the valve body being configured for movement between a first position and a second position when the vehicle reaches a threshold vehicle speed;
a valve body seal configured for sealing engagement between the valve housing and the valve body to prevent two-way flow of fluid through said first valve when the valve body is in said first position;
the valve body being configured to sealingly disengaged from the valve housing to provide two-way flow of fluid through said first valve when the valve body is in said second position; and
a compressible member or spring coupled to said valve body to provide a spring force biasing the valve body into the first position.

2. The vehicle tire pressure regulation system of claim 1, said first valve being included within a common housing of said rotary union.

3. The vehicle tire pressure regulation system of claim 1, said first valve being connected to said rotary union at a port of said rotary union.

4. The vehicle tire pressure regulation system of claim 1, said first valve being connected to said rotary union by a threaded connection.

5. The vehicle tire pressure regulation system of claim 1, said first valve being connected to said rotary union using a swivel nut.

6. The vehicle tire pressure regulation system of any of claims 1-5, said valve body being positioned at a distance between about 1 inch to about 5 inches from said rotational axis when the first valve is connected to said rotary union.

7. The vehicle tire pressure regulation system of any of claims 3-5, said first valve being integrated together with a fluid conduit in the form of a conduit assembly, the conduit assembly being configured for routing fluid to said first vehicle tire.

8. The vehicle tire pressure regulation system of claim 1 further comprising:
a second valve configured for controlling two-way fluid communication between said rotary union and said second vehicle tire.

9. The vehicle tire pressure regulation system of claim 8, the tire pressure regulation system being configured for two-way fluid communication between said first vehicle tire and said second vehicle tire.

10. The vehicle tire pressure regulation system of claim 9, said tire pressure regulation system being configured for two-way fluid communication between said first vehicle tire and said second vehicle tire when the vehicle is travelling at highway speeds.

11. The vehicle tire pressure regulation system of claim 1 further comprising:
a pressure relief valve positioned distally from said first valve.

12. The vehicle tire pressure regulation system of claim 1, said first valve further comprising an auxiliary port, the auxiliary port comprising a pressure relief valve.

13. The vehicle tire pressure regulation system of claim 1, said first valve further comprising an auxiliary port, the auxiliary port comprising a pressure sensor.

14. The vehicle tire pressure regulation system of claim 1, said first valve further comprising a first auxiliary port and a second auxiliary port.

15. The system of claim 1 further comprising an auxiliary port disposed within said valve housing.

16. The system of claim 15, said auxiliary port comprising a tire filling adapter.

17. The system of claim 15, said auxiliary port comprising a pressure relief valve.

18. The system of claim 17 wherein said pressure relief valve is configured to minimize a force supplied on the valve body by fluid pressure on the tire side of said first valve.

19. The system of claim 17 wherein said pressure relief valve is positioned distally from said valve body seal.

20. The system of any of claim 1 wherein said valve body seal is disposed in a groove formed within said valve body.

21. The system of claim 1, said valve body comprising a central section, a groove, and a sealing body, the groove being formed between the sealing body and the central section.

22. The system of claim 21 wherein said central section comprises a different shape than does said sealing body.

23. The system of claim 21 wherein said central section comprises a hexagonal cross-sectional shape and said sealing body comprises a cylindrical cross-sectional shape.

24. The system of claim 21 wherein said valve body comprises a spring bracing face against which an end of the spring may abut, the spring bracing face comprising a reaction face through which said spring force may be transferred to the valve body.

25. The system of claim 1 further comprising:
a tee-body connection, the tee-body comprising a part of a rotary union housing or being mounted to the rotary union;
said valve comprising a part of said tee-body connection.

26. The system of claim 1 further comprising:
a tee-body connection, the tee-body comprising a part of a rotary union housing or being mounted to the rotary union;
said valve housing being connected to said tee-body connection.

27. The system of claim 26, said valve housing being coupled to said tee-body connection using a swivel nut and one or more snap rings.

28. The system of claim 1 wherein said valve body comprises a solid core.

29. The system of claim 1 wherein said valve body comprises a longitudinal channel including a check valve disposed therein.

30. The system of claim 1 wherein said valve body is made from tungsten.

31. The system of claim 1 wherein said valve housing is made from brass.

32. The system of claim 1 wherein said valve body comprises a packing, the packing being secured about the valve body.

33. The system of claim 1 wherein said valve body comprises a packing, the packing being secured about the valve body in a groove disposed therein.

34. The system of claim 1 wherein said valve body comprises a packing, the packing being secured to the valve housing.

35. The system of claim 1 wherein said valve body comprises a packing an O-ring or a square profiled O-ring.

36. A valve configured for controlling two-way fluid communication therethrough comprising:
a valve housing;
a valve body enclosed within said valve housing, the valve body comprising an inertial mass subject to centrifugal forces when a center of mass of the valve body is positioned at a distance away from said rotational axis and subjected to centrifugal forces when a vehicle is in motion, the valve body being configured for movement between a first position and a second position when the vehicle reaches a threshold vehicle speed;
a valve body seal configured for providing sealing engagement between the valve housing and the valve body to prevent two-way flow of fluid through said valve when the valve body is in said first position;
the valve body being configured to sealingly disengaged from the valve housing to provide two-way flow of fluid through said valve when the valve body is in said second position; and
a compressible member or spring coupled to said valve body to provide a spring force biasing the valve body into the first position.

37. The valve of claim 36, the valve housing being a common housing of a rotary union.

38. The valve of claim 36, the valve housing being a common housing of a tee-body connection.

39. The valve of claim 36 further comprising an auxiliary port, the auxiliary port including a pressure relief valve.

40. The valve of claim 36, said t valve further comprising an auxiliary port, the auxiliary port comprising a pressure sensor.

41. The valve of claim 36, said valve further comprising a first auxiliary port and a second auxiliary port.

42. The valve of claim 36 further comprising an auxiliary port.

43. The valve of claim 42, said auxiliary port comprising a tire filling adapter.

44. The valve of claim 42, said auxiliary port comprising a pressure relief valve.

45. The valve of claim 36 wherein said valve body comprises a solid core.

46. The valve of claim 36 wherein said valve body comprises a longitudinal channel including a check valve disposed therein.

47. The valve of claim 36 wherein said valve body is made from tungsten.

48. The valve of claim 36 wherein said valve housing is made from brass.

49. A vehicle tire pressure equalization system configured for mounting to a vehicle hubcap at a wheel end of a vehicle including a rotational axis, the wheel end being configured for supporting each of a first vehicle tire and a second vehicle tire, the tire pressure equalization system comprising:
a first valve configured for controlling two-way fluid communication therethrough, the valve comprising:
a valve housing;
a valve body enclosed within said valve housing, the valve body comprising an inertial mass subject to centrifugal forces when the valve body is positioned at a distance away from said rotational axis and subjected to centrifugal forces when the vehicle is in motion, the valve body being configured for movement between a first position and a second position when the vehicle reaches a threshold vehicle speed;
a valve body seal configured for sealing engagement between the valve housing and the valve body to prevent two-way flow of fluid through said valve when the valve body is in said first position;
the valve body being configured to sealingly disengaged from the valve housing to provide two-way flow of fluid through said valve when the valve body is in said second position; and
a compressible member or spring coupled to said valve body to provide a spring force biasing the valve body into the first position.

50. The vehicle tire pressure equalization system of claim 49 further comprising a second valve configured for allowing two-way fluid communication therethrough.

51. The vehicle tire pressure regulation system of claim 50, the vehicle tire pressure equalization system being configured for two-way fluid communication between said first vehicle tire and said second vehicle tire.

52. The vehicle tire pressure regulation system of claim 51, said tire pressure regulation system being configured for two-way fluid communication between said first vehicle tire and said second vehicle tire when the vehicle is travelling at highway speeds.

53. The vehicle tire pressure regulation system of claim 50, said first valve and said second valve being enclosed in a common housing.

54. A vehicle tire pressure regulation system comprising:
a valve configured for mounting at a wheel end of a vehicle, the wheel end including a rotational axis, the valve comprising:
a valve housing;
a valve body enclosed within said valve housing, the valve body comprising an inertial mass subject to centrifugal forces when a center of mass of the valve body is positioned at a distance away from said rotational axis and subjected to centripetal motion during vehicle travel, the valve body being configured for movement between a first position and a second position when the vehicle reaches a vehicle speed within a threshold range of vehicle speeds;
the valve body sealingly engaged with a valve body seal so as to prevent two-way flow of fluid through said valve when in said first position;
the valve body being sealingly disengaged with the valve body seal so as to enable two-way flow of fluid through said valve when in said second position;
a spring positioned so as to provide a spring force biasing the valve body into the first position; and
said valve body seal.

55. The system of claim 54 said valve body seal being sealingly engaged between said valve body and said valve housing when said valve body is positioned in said first position.

56. The system of claim 55 said valve body seal being sealingly disengaged when the valve body moves to said second position;
the valve providing for two-way flow of fluid through a fluid channel disposed between the valve housing and the valve body when the valve body is in said second position.

57. The system of claim 54 further comprising an auxiliary port disposed within said valve housing.

58. The system of claim 57, said auxiliary port comprising a pressure relief valve.

59. The system of claim 58 wherein said pressure relief valve is configured to minimize a force supplied on the valve body by fluid pressure on the tire side of said valve so as to enable the valve to open within said threshold range of vehicle speeds even if the tire is over pressurized when the vehicle begins moving.

60. The system of claim 59 wherein said pressure relief valve is specified to relieve inflation pressure from said vehicle tire when the vehicle tire is inflated to a level that is more than about 10% to about 25% greater than a specified vehicle tire pressure.

61. The system of any of claim 54 wherein said sealing member is disposed in a groove formed within said valve body.

62. The system of claim 54, said valve body comprising a central section, a groove, and a sealing body, the groove being formed between the sealing body and the central section.

63. The system of claim 54 wherein said central section comprises a different shape than does said sealing body.

64. The system of claim 54 wherein said central section comprises the same shape as said sealing body.

65. The system of claim 54 wherein said central section comprises a hexagonal cross-sectional shape and said sealing body comprises a cylindrical cross-sectional shape.

66. The system of claim 54 wherein said valve body comprises a spring bracing face against which an end of the spring may abut, the spring bracing face comprising a reaction face through which said spring force may be transferred to the valve body.

67. The system of claim 54 further comprising:
a rotary union connection;
said valve being mounted in sealed fluid communication with said rotary union connection;
said valve housing comprising a chamber allowing for communication of pressurized fluid against said valve body.

68. The system of claim 54 further comprising:
a rotary union connection;
said valve being mounted within said rotary union housing.

69. The system of claim 54 further comprising:
a rotary union connection;
a tee-body connection, the tee-body comprising a part of a rotary union housing or being mounted to the rotary union;
said valve comprising a part of said tee-body connection.

70. The system of claim 54 further comprising:
a rotary union connection;
a tee-body connection, the tee-body comprising a part of a rotary union housing or being mounted to the rotary union;
said valve housing being connected to said tee-body connection.

71. The system of claim 54 wherein said valve body comprises a solid core.

72. The system of claim 54 wherein said valve body comprises a longitudinal channel including a check valve disposed therein.

73. A vehicle tire pressure regulation system for a vehicle including a first wheel end and a first vehicle tire mounted thereto, the system comprising:
a fluid pressure source;
a rotary union in a path of sealed fluid communication extending from the fluid pressure source to said first vehicle tire;
a valve disposed in said path of sealed fluid communication between the rotary union and the first vehicle tire, the valve comprising:
a valve housing including an inlet port and an outlet port;
a valve body enclosed within said valve housing, the valve body comprising an inertial mass subject to centrifugal forces when the vehicle is in motion, the valve body being configured for translating between a first position wherein the valve body sealingly engages a valve body seal so as to prevent two-way flow of fluid between said inlet port and said outlet port and a second position wherein the valve body is not sealingly engaged with the valve body seal so as to enable two-way flow of fluid between said inlet port and said outlet port;
a spring configured for providing a spring force biasing the valve body into the first position;
an auxiliary port disposed within said valve housing downstream of said valve body seal; and
said valve body seal.

74. The system of claim 73, wherein said valve body seal is sealingly engaged between said valve body and said valve housing when said valve body is positioned in said first position.

75. The system of claim 74 wherein said valve body seal is sealingly disengaged when the valve body moves to said second position;
the valve providing for two-way flow of fluid through a fluid channel disposed between the valve housing and the valve body when the valve body is in said second position.

76. The system of claim 73 wherein said valve body seal comprises an o-ring.

77. The system of claim 73, said auxiliary port comprising a pressure relief valve.

78. The system of claim 77, said valve body being configured for translation between said first position and said second position so as to open the valve when the vehicle exceeds a threshold speed, the pressure relief valve being configured to relieve excess fluid pressure on the valve body so as to minimize an effect of over pressurization of the first vehicle tire on the threshold speed at which the first vehicle tire opens.

79. The system of claim 73, said valve providing sealed fluid communication between a rotary union connection and a vehicle tire;
said auxiliary port being disposed downstream from said valve body seal when the valve is mounted between the rotary union and said vehicle tire, the auxiliary port being in fluid communication with said vehicle tire when the valve body is in said first position.

80. The system of claim 73 wherein said valve body includes a check valve configured for one way flow of fluid through the valve when a pressure differential exists between said inlet port and said outlet port.

81. The system of claim 73 wherein said check valve is disposed in a longitudinal channel formed within said valve body.

82. The system of claim 73 wherein said pressure source comprises an electronic control box with pressure regulating capabilities.

83. The system of claim 73, the sealed path of fluid communication including one or more check valves disposed between said pressure source and said rotary union.

84. A valve comprising:
a valve housing including an inlet port and an outlet port;
a valve body enclosed within said valve housing, the valve body comprising an inertial mass subject to centrifugal forces when the valve is mounted at the wheel end of a moving vehicle, the valve body being configured for translating between a first position wherein the valve body sealingly engages a valve body seal so as to prevent two-way flow of fluid between said inlet port and said outlet port and a second position wherein the valve body is not sealingly engaged with the valve body seal so as to enable two-way flow of fluid between said inlet port and said outlet port;
a spring configured for providing a spring force biasing the valve body into the first position;
an auxiliary port disposed within said valve housing downstream of said valve body seal; and
said valve body seal.

85. The valve of claim 84, said valve body comprising a first cylindrical portion, second cylindrical portion, central section, and a third cylindrical portion.

86. The valve of claim 85 said valve body comprising a pair of grooves configured for accepting a pair of snap rings.

87. The valve of claim 84, the inlet port comprising a smaller diameter than the outlet port.

88. The valve of claim 84 wherein the valve body is made from brass.

89. The valve of claim 84 wherein said valve body seal comprises an o-ring.

90. The valve of claim 84, said auxiliary port comprising a pressure relief valve.

91. The valve of claim 84, said auxiliary port comprising an inflation port.

92. The valve of claim 91 wherein said pressure relief valve is formed within a cap of said auxiliary port.

93. The valve of claim 84, said valve body comprising a central section, a groove, and a sealing body, the groove being formed between the sealing body and the central section.

94. The valve of claim 93, wherein said central section comprises a different shape than does said sealing body.

95. The valve of claim 93, wherein said central section comprises the same shape as said sealing body.

96. The valve of claim 93 wherein said sealing body comprises a smaller cross section than does said central section.

97. The valve of claim 93 wherein said valve comprises a generally cylindrical mass with stepped regions at each end.

98. A vehicle tire pressure regulation system comprising:
a valve assembly configured for mounting at a wheel end of a vehicle, the wheel end including a rotational axis, the valve assembly including a housing body enclosing a central chamber and two or more arms extending outwards from the central chamber, each of the two or more arms comprising:
a valve body, the valve body comprising an inertial mass subject to centrifugal forces when a center of mass of the valve body is positioned at a distance away from said rotational axis and subjected to centripetal motion during vehicle travel, the valve body being configured for movement between a first position and a second position when the vehicle reaches a vehicle speed within a threshold range of vehicle speeds;
the valve body being sealingly engaged with a first seal so as to prevent two-way flow of fluid when in said first position;
the valve body being sealingly disengaged with the valve body seal so as to enable two-way flow of fluid when in said second position; and
a spring positioned so as to provide a spring force biasing the valve body into the first position.

99. The system of claim 98 wherein each of the arms includes an outlet port disposed distally from said central chamber.

100. The system of claim 99 wherein said outlet port is configured to receive a check valve assembly.

101. The system of claim 99 said first seal providing sealing engagement between said valve body and said housing body when said valve body is positioned in said first position.

102. The system of claim 101 said first seal being sealingly disengaged when the valve body moves to said second position.

103. The system of claim 98 wherein each of said two or more arms allows for two-way communication of fluid between said central chamber and a vehicle tire disposed thereto when a valve body disposed therein is moved to said second position.

104. The system of claim 98 wherein said valve body includes a check valve configured for one way flow of fluid through the valve even when the valve is maintained in said first position.

105. The system of claim 104 wherein said check valve is disposed in a longitudinal channel formed within said valve body.

106. A valve assembly configured for mounting at a wheel end of a vehicle, the wheel end including a rotational axis, the valve assembly including a housing body enclosing a central chamber and two or more arms extending outwards from the central chamber, each of the two or more arms comprising:
a valve body, the valve body comprising an inertial mass subject to centrifugal forces when a center of mass of the valve body is positioned at a distance away from said rotational axis and subjected to centripetal motion during vehicle travel, the valve body being configured for movement between a first position and a second position when the vehicle reaches a vehicle speed within a threshold range of vehicle speeds;
the valve body being sealingly engaged with a first seal so as to prevent two-way flow of fluid when in said first position;
the valve body being sealingly disengaged with the valve body seal so as to enable two-way flow of fluid when in said second position; and
a spring positioned so as to provide a spring force biasing the valve body into the first position.

107. A valve assembly configured for mounting at a wheel end of a vehicle, the wheel end including a rotational axis, the valve assembly comprising:
a housing body; and
a first flow control assembly configured for connection to the housing body, the first flow control assembly comprising:
a flow control assembly housing;
a valve body disposed within said flow control assembly housing, the valve body including an inertial mass subject to centrifugal forces when a center of mass of the valve body is positioned at a distance away from a rotational axis and subjected to centripetal motion during vehicle travel, the valve body being configured for actuating a check valve in response to said centrifugal forces; and
said check valve.

108. The valve assembly of claim 107 wherein said valve body is configured to actuate said check valve when the vehicle is traveling at a threshold speed.

109. The valve assembly of claim 107, said flow control assembly further comprising:
a spring configured to hold the valve body in a closed position when the valve body is not being subjected to centripetal motion.

110. The valve assembly of claim 107 said flow control assembly further comprising:
a detent disposed on the valve body and configured for holding the valve body against the check valve.

111. The valve assembly of claim 110 wherein said check valve includes a plunger, the valve body being held within the flow control assembly housing so that the valve body is forced against the plunger when the valve is subject to centripetal motion so as to actuate said check valve.
